(19) United States
(12) Patent Application Publication
(10) Pub. No.: US 2009/0156234 A1
(43) Pub. Date: Jun. 18, 2009

(54) GUIDE INFORMATION PROVIDING SYSTEM, GUIDE INFORMATION PROVIDING METHOD, SERVER DEVICE, TERMINAL DEVICE

(75) Inventors: Yoichiro Sako, Tokyo (JP); Mitsuru Takehara, Tokyo (JP); Masamichi Asukai, Kanagawa (JP); Taiji Ito, Kanagawa (JP); Akinobu Sugino, Kanagawa (JP); Akane Sano, Tokyo (JP); Yoshiteru Kamatani, Kanagawa (JP); Takayasu Kon, Tokyo (JP); Yasunori Kamada, Kanagawa (JP); Kazunori Hayashi, Tokyo (JP)

Correspondence Address: WOLF GREENFIELD & SACKS, P.C., 600 ATLANTIC AVENUE, BOSTON, MA, 02210-2206, US

(73) Assignee: SONY CORPORATION, Tokyo (JP)

(21) Appl. No.: 12/330,963

(22) Filed: Dec. 9, 2008

(30) Foreign Application Priority Data
Dec. 14, 2007 (JP) 2007-323654

(51) Int. Cl. H04W 24/00

(52) U.S. Cl. 455/456.3

(57) ABSTRACT

A guide information providing system including terminal and server devices, comprising: a specified location acceptance unit in the terminal device, to accept input of a specified location; a display unit in the terminal device, to display information; a storing unit, in the server device, to store guide information classified by position wherein guide information including time-of-day information, and position information, of an object of guiding, are correlated; an information selecting unit to select guide information correlated with position information indicating the position corresponding to the specified location based on the content of specified location information accepted by the specified location acceptance unit, and the guide information classified by position, and satisfies a time-of-day condition with at least the current time-of-day and thereafter as reference; and a display control unit in the terminal device, configured to control the display unit to provide the guide information selected by the information selecting unit, and position information correlated with the guide information thereof, to a user in a predetermined display format.

### CROSS REFERENCES TO RELATED APPLICATIONS

The present invention contains subject matter related to Japanese Patent Application JP 2007-323654 filed in the Japanese Patent Office on Dec. 14, 2007, the entire contents of which are incorporated herein by reference.

### BACKGROUND OF THE INVENTION

1. Field of the Invention

The present invention relates to a guide information providing system, which is configured so as to include a terminal device and server device, and provides guide information regarding stores, movies, events, or the like, for example, and a method thereof, and also relates to a server device and terminal device serving as components of the guide information providing system.

2. Description of the Related Art

Hitherto, with navigation systems such as car navigation systems and so forth for example, there have been some systems for displaying information relating to a place specified on a map. For example, in a case wherein a specified place is a store or facility, some systems display guide information on the place thereof, such as the phone number information and business-hours information thereof, and so forth. Examples of such related art can be found in, for example, Japanese Unexamined Patent Application Publication No. 2005-331511 and Japanese Unexamined Patent Application Publication No. 2003-214889.

### SUMMARY OF THE INVENTION

Now, it is very likely that display of guide information such as described above is executed on the assumption that a user himself/herself is looking for a desired store for example, and further will being going to that store straightaway. Taking this into consideration, information regarding stores or the like which are open for business, and not stores or the like which have closed for the day, should be displayed as guide information.

With a system according to the related art, guide information correlated with the position corresponding to a specified place is simply selected and displayed. That is to say, with a system according to the related art, the concept of time-of-day is not taken into consideration at the time of displaying guide information, and information of a store or the like which has already closed for the day is also displayed unintentionally. Thus, with a system according to the related art, efficient use of limited display space is not realized at the time of displaying guide information in that information of which the demand is low is also displayed unintentionally. Also, irrelevant information and relevant information are displayed together, so searching of a store or the like which a user desires is not smooth, and the irrelevant information prevents smooth searching. There has been found demand for providing of a guide information providing system addressing such problems.

That is to say, a guide information providing system according to an embodiment of the present invention is configured so as to include a terminal device, and server device, with a specified place acceptance unit provided in the terminal device to accept input of a specified place. A display unit is provided in the terminal device to display information, and a storing unit is provided in the server device to store guide information classified by position wherein guide information including time-of-day information, and position information, of a thing which is the object of guiding are correlated.

An information selecting unit is provided to select guide information which is correlated with position information indicating the position corresponding to the specified place based on the content of specified place information of which the input has been accepted by the specified place acceptance unit, and the guide information classified by position, and satisfies a time-of-day condition with at least the current time-of-day and thereafter as reference. A display control unit is provided in the terminal device to control the display unit so as to provide the guide information selected by the information selecting unit, and position information correlated with the guide information thereof to a user in a predetermined display format.

With the above configuration, there is employed information wherein guide information and position information are correlated at the time of providing of guide information.

Further, the guide information includes time-of-day information regarding the guide target, and this time-of-day information is employed to select guide information satisfying a time-of-day condition with a time-of-day of at least the current time-of-day and thereafter as reference, of guide information correlated with the position corresponding to a specified place. Thus, the guide information corresponding to the specified place can be narrowed down to only guide information satisfying the time-of-day condition, as guide information to be displayed.

For example, in a case wherein the guide information is guide information regarding a store or facility, which includes business-hours information (start time-of-day to end time-of-day), a condition can be employed as the time-of-day condition wherein the closing hour time-of-day is at least the current time-of-day or thereafter, and thus, only guide information regarding a store or facility under business can be displayed.

Alternatively, in a case wherein the guide information is, for example, movie screen guide information including showing time information for each title, a condition can be employed as the time-of-day condition wherein a showing start time-of-day is at least the current time-of-day and thereafter, and thus, only guide information regarding a move which can be viewed from now on can be displayed, for example.

With the above configuration, time-of-day information is included in guide information, and guide information is selected based on the time-of-day information thereof, whereby only relevant guide information can be displayed wherein guide information regarding a store or facility of which the business has already ended is excluded, for example. Thus, only relevant guide information can be displayed, whereby efficient use of limited display space can be realized at the time of providing guide information. Further, displaying only relevant guide information means that irrelevant information does not get in the way as with the related art.

### BRIEF DESCRIPTION OF THE DRAWINGS

FIG. 1 is a diagram for describing the overview of a guide information presenting system according to an embodiment of the present invention;

FIG. 2 is a block diagram illustrating the internal configuration of a terminal device according to an embodiment;

FIG. 3 is a block diagram illustrating the internal configuration of a server device according to an embodiment;

FIGS. 4A through 4E are diagrams illustrating a guide information database according to an embodiment;

FIG. 5 is a diagram schematically illustrating the overview of operations performed at the guide information presenting system according to a first embodiment;

FIGS. 6A through 6C are diagrams illustrating screen examples displayed corresponding primarily to location specification to genre specification, as a diagram for describing a screen transition example displayed at the terminal device side corresponding to the time of guide information presenting operations;

FIG. 7 is a diagram illustrating an example of a guide information on-map display screen (case wherein specified genre is “eat”), as a diagram for describing a screen transition example displayed at the terminal device side corresponding to the time of guide information presenting operations;

FIG. 8 is a diagram illustrating an example of a guide information on-map display screen (case wherein specified genre is “movie”), as a diagram for describing a screen transition example displayed at the terminal device side corresponding to the time of guide information presenting operations;

FIGS. 9A through 9C are diagrams illustrating an example of screen transition displayed corresponding to presenting detailed information of guide information up to starting route navigation;

FIG. 10 is a flowchart illustrating processing operations to be executed to realize the operations as the first embodiment;

FIG. 11 also is a flowchart illustrating processing operations to be executed to realize the operations as the first embodiment;

FIG. 12 is a diagram schematically illustrating the overview of operations performed at the guide information presenting system according to a second embodiment;

FIGS. 13A and 13B are diagrams illustrating an example of screen transition displayed corresponding to presenting detailed information of guide information with the second embodiment;

FIG. 14 is a flowchart illustrating processing operations to be executed to realize the operations as the second embodiment; and

FIG. 15 also is a flowchart illustrating processing operations to be executed to realize the operations as the second embodiment.

### DESCRIPTION OF THE PREFERRED EMBODIMENTS

Embodiments for carrying out the present invention will be described below.

### First Embodiment

### Overview of Guide Information Providing System

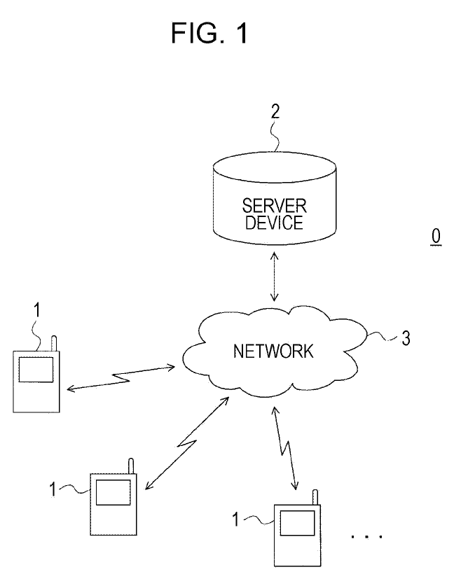

FIG. 1 is a diagram for describing overview of a guide information system 0 serving as an embodiment of the guide information providing system of the present invention. In FIG. 1, the guide information providing system 0 serving as an embodiment is configured so as to include multiple terminal devices 1, a server device 2, and a network 3. The terminal devices 1 and server device 2 have each a network connection function, and are mutually capable of data communication through the network 3.

The terminal devices 1 have portability, and are assumed to be employed principally by the user outside of the home. The terminal devices 1 are, for example, electronics devices including a GPS (Global Positioning System) receiving unit whereby the current position can be detected. For example, the terminal devices 1 can be configured as a cellular phone, PDA (Personal Digital Assistants), personal computer (a type having portability, such as a note type), audio player, digital camera, or the like.

In this case, the terminal devices 1 include a later-described map database, and are capable of display of a map image. Also, particularly, in the case of the first embodiment, the terminal devices 1 have a route search function, whereby route navigation to a specified position can be performed.

Guide information regarding, for example, stores, facilities, various types of events, and so forth is stored by position in the server device 2 (later-described guide information database). This guide information database is successively updated to the latest information, for example, by a supplier or the like who provides a service realized by the guide information providing system 0. As described later, the server device 2 transmits guide information selected from the guide information database to the terminal device 1, thereby causing the terminal device 1 side to display the guide information.

### Configuration Example of Terminal Devices

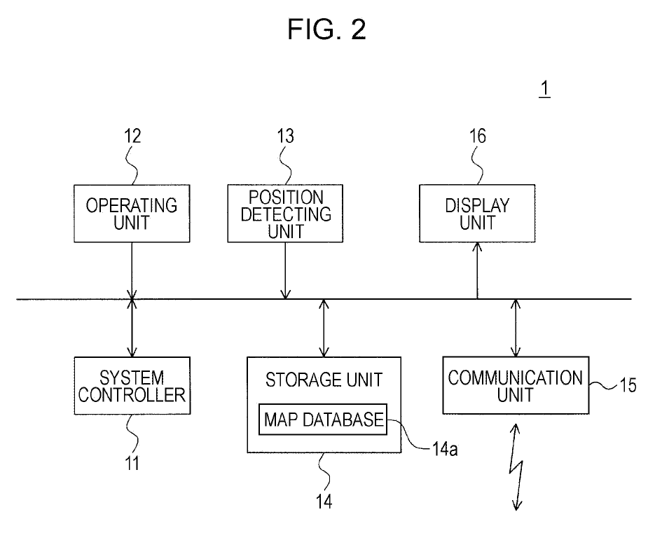

FIG. 2 is a block diagram illustrating the internal configuration of the terminal devices 1 shown in FIG. 1. As shown in FIG. 2, the terminal devices 1 include a system controller 11, operating unit 12, position detecting unit 13, storing unit 14, and communication unit 15.

The system controller 11 is configured of, for example, a microcomputer including a CPU (Central Processing Unit), ROM (Read Only Memory), RAM (Random Access Memory), nonvolatile memory unit, and an interface unit, and serves as a control unit for controlling the entirety of the terminal device 1.

The system controller 11 controls each unit within the terminal device 1 based on an operating program stored in storing means, for example, such as the ROM or the like, and causes the unit to execute relevant operations.

The operating unit 12 is provided as operating elements such as keys, dial, or the like for allowing a user using the terminal device 1 to perform various types of operations. For example, there are provided operating elements for performing power on/off operations, start instructing operations for various types of operation, and so forth. Also, in this case, there are provided operating elements such as a d-pad for performing scrolling of a map image, and selection of various types of items, an operating element for instructing directions, and an enter key for entering (deciding) a selected item, and so forth. The system controller 11 performs predetermined control processing based on operation information from the operating unit 12. Thus, operation corresponding to operating input is executed with the terminal device 1.

The position detecting unit 13 is configured so as to include, for example, a GPS receiving unit, and detects the current position of the terminal device 1. In this case, the GPS receiving unit receives electric waves from an unshown GPS satellite, and outputs latitude and longitude information serving as the current position to the system controller 11. Note that the position detecting unit 13 can be configured so as to utilize a position information service provided by Wi-Fi (Wireless Fidelity) or cellular phone company.

The storing unit 14 performs recording (saving) of various types of data, playback (reading) of recorded data based on the control of the system controller 11. The storing unit 14 may be configured of solid-state memory such as RAM, flash memory, or the like, or may be configured of an HDD (Hard Disk Drive), for example. Alternatively, the storing unit 14 may be configured of a recording/playback drive compatible with a recording medium having portability, e.g., a recording medium such as a memory card including solid-state memory, optical disc, magneto-optical disk, hologram memory, or the like. It goes without saying that both of built-in type memory such as solid-state memory, HDD, or the like, and a recording/playback drive compatible with a portable recording medium, may be implemented as the storing unit 14.

A map database 14a for enabling display of a map image is stored in the storing unit 14. The map database 14a stores map image data which covers the inside of a predetermined region (e.g., inside of Japan), and other data used for display of a map image.

The communication unit 15 performs transmission/reception of data with an external deice. The communication unit 15 may be a unit which is connected to a network by cable or wireless to perform communication.

With the display unit 16, there are provided a display panel unit, for example, such as a liquid crystal panel, organic EL panel, or the like, and a display driving unit for driving the display panel unit. The display driving unit is configured of a pixel driving circuit for driving the display panel to display supplied image data. The pixel driving circuit applies a driving signal based on a picture signal to each pixel disposed in the display panel unit in a matrix form at predetermined horizontal/vertical timing to cause the pixel to execute display.

The display unit 16 causes the display panel unit to execute predetermined display based on the control of the system controller 11. Particularly, with the present example, the system controller 11 supplies image data generated by the system controller 11 based on the information within the map database 14a stored in the storing unit 14 to the display unit 16, and causes the display unit 16 to execute display of a map image. Also, the system controller 11 instructs image data such as an icon or the like and the display position thereof in the display unit 16, whereby a predetermined image can be displayed on a predetermined position on a map image.

### Configuration Example of Server Device

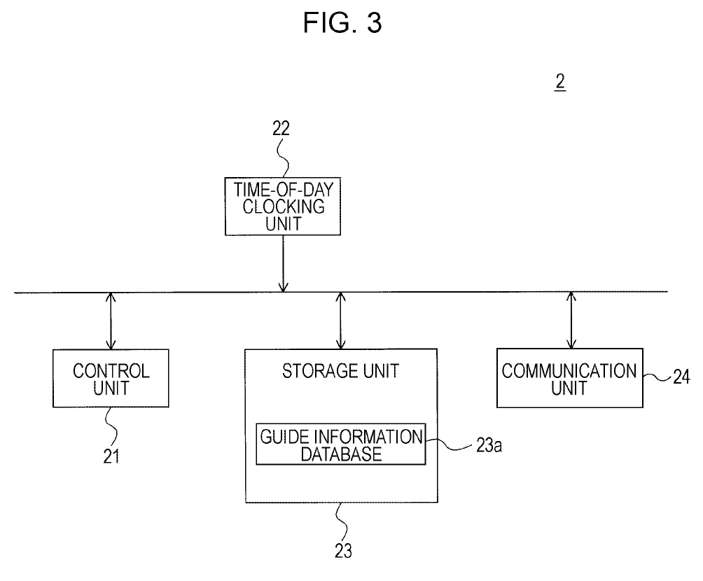

FIG. 3 is a block diagram illustrating the internal configuration of the server device 2. The server device 2 includes a control unit 21, time-of-day clocking unit 22, storing unit 23, and communication unit 24. In FIG. 3, the control unit 21 performs the entire control of the server device 2. The control unit 21 is configured of a CPU, ROM, RAM, nonvolatile memory unit, interface unit, and so forth, controls each unit within the server device 2 based on an operating program stored in, for example, storing means such as the ROM or the like, and causes the unit to execute relevant operations.

The time-of-day clocking unit 22 clocks the current time-of-day, in yyyy/mm/dd/hh/mm/ss for example, and outputs current time-of-day information thus obtained to the control unit 21. Note that the time-of-day clocking unit 22 is shown here as if the time-of-day clocking unit 22 is a separate hardware, but in reality, this can be implemented as a part of the function according to the control unit 21.

The storing unit 23 performs recording or playback of various types of data based on the control of the control unit 21. The storing unit 23 may also be configured of solid-state memory such as RAM or flash memory or the like, or may be configured of an HDD (Hard Disk Drive), for example. Alternatively, instead of a built-in storage medium, the storing unit 23 may be configured of a recording/playback drive compatible with a recording medium having portability, e.g., a recording medium such as a memory card including solid-state memory, optical disc, magneto-optical disk, hologram memory, or the like. Alternatively, both of built-in type memory such as solid-state memory, HDD, or the like, and a recording/playback drive compatible with a portable recording medium may be implemented as the storing unit 23.

Note that with the present example, consequently, a guide information database 23a is to be compiled in the storing unit 23, regarding which description will be made later.

The communication unit 24 performs transmission/reception of data with an external device. The communication unit 24 in the server device 2 may be basically a unit which is connected to a network by cable to perform communication, but may also be configured to connect to a network by wireless.

### Guide Information

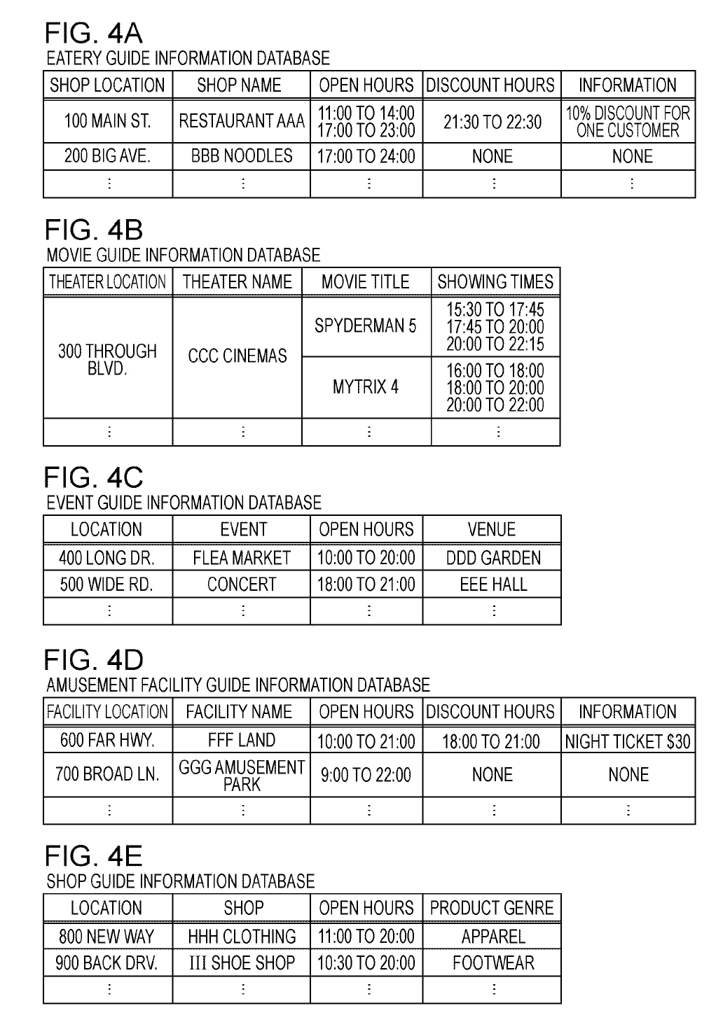

Now, the guide information database 23a will be described with reference to FIGS. 4A through 4E. First, as an assumption, with the guide information presenting system 0 according to the present example, the guide information is divided into five genres of eatery guide information, movie guide information, event guide information, entertainment facility guide information, and shop guide information. That is to say, the guide information database 23a is made up of a guide information database of these genres.

Specifically, the guide information database 23a in this case is made up of an eatery guide information database (hereinafter abbreviated to DB) shown in FIG. 4A, a movie guide information DB shown in FIG. 4B, an event guide information DB shown in FIG. 4C, an amusement facility guide information DB shown in FIG. 4D, and a shop guide information DB shown in FIG. 4E.

Now, the eatery guide information is guide information regarding places to eat or drink (hereinafter also called eatery) such as restaurants, bars, diners, and so forth, for example.

Also, movie guide information is guide information regarding movies shown at movie showing facilities such as movie theaters or the like.

Event guide information is guide information regarding concerts, live performances, flea markets, and festivals, for example.

Amusement facility guide information is guide information regarding entertainment facilities (amusement facilities) such as amusement parks, swimming pool facilities, and bowling alleys, for example.

Also, shop guide information is guide information regarding shops which sell goods such as apparel shops, shoe stores, department stores, and home appliance discounters, for example.

The eatery guide information DB shown in FIG. 4A is formed of information of shop name, open hours of the shop, and further information of discount hours and details thereof, correlated for each shop position information (i.e., for each shop). The open hours information of the shops is information represented as the opening time and closing time. Also, in the event that the open hours of the shop are split into lunch time and dinner time for example, the opening time and closing time of each is described. The discount hours information is information representing time periods where various types of discounts, such as lunch time discount for example, is provided.

The movie guide information DB shown in FIG. 4B is formed of facility name, information of movie titles shown at that facility, and information of showing times of the titles (starting time to end time) of the titles, correlated for each information of facilities showing movies. In the event that multiple movie titles are to be shown at the facility, multiple title information are correlated with one information of facility showing movies. Also, in the event that a certain movie title is to be shown multiple times at the movie facility, multiple time information are correlated with one title information.

Also, with the event guide information DB shown in FIG. 4C, information of the content of the event shown at that position, information of event times (start time to end time), and information of the name of the venue, are correlated for information of position where the event is held.

Also, with the amusement facility guide DB shown in FIG. 4D, information of the name of the facility, open hours (opening time to closing time) information, and further information of discount hours and details thereof, correlated for each information of position of amusement facility. Examples of discount hours of an amusement facility might be time periods when discount tickets are being sold, for example.

Also, with the shop guide information DB shown in FIG. 4E, information of the name of the shop, the open hours (opening time through closing time) information, and product genre information are correlated for each information of position of shopping shop. For product genre information, genre information of products handled at that shop are described.

### Guide Information Presentation

As can be understood from the above description, with the present embodiment, guide information for guiding regarding shops and facilities, events and so forth, include time-of-day information regarding things to be objects of guiding. Now, the probability is high that such guide information will be displayed assuming that the user will find a desired shop, facility, event, or the like, and go to the shop, facility, event, or the like. Taking this into consideration, guide information regarding shops, facilities, or events, which have already closed for the day, is irrelevant information.

Accordingly, with the present embodiment, guide information is included with time-of-day information, with guide information being selected by preventing display of irrelevant guide information, using the time-of-day information. Specifically, with the first embodiment, from the perspective of preventing display of guide information relating to shops and facilities which have already closed for the day, only guide information satisfying time-of-day conditions based on the current time-of-day is selected and displayed. The following is a description of a guide information presenting technique as such a first embodiment.

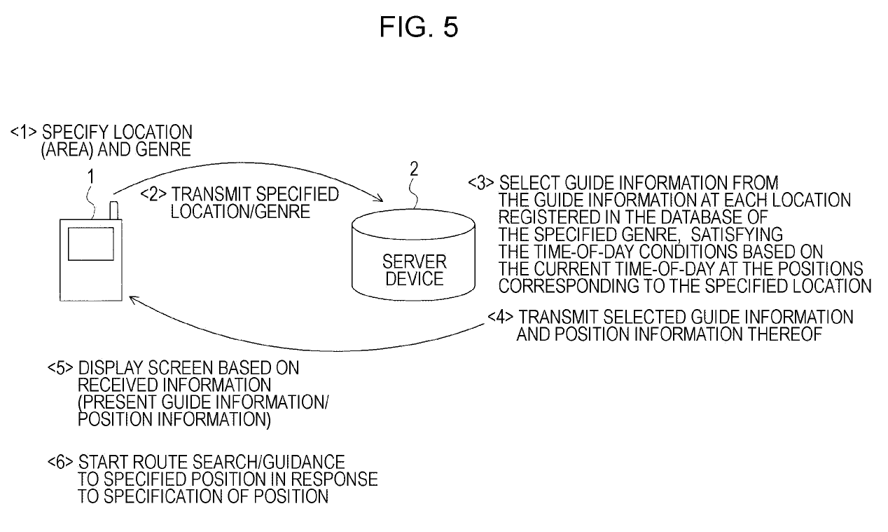

FIG. 5 is a diagram schematically illustrating guide information presenting operations with the guide information presenting system 0 performs. Note that the network 3 shown in FIG. 1 has been omitted from this FIG. 5. In FIG. 5, first, and that terminal device 1 side, location and genre are specified, as indicated by <1> in the drawing. Here, specification of a location is performed not regarding a pinpoint position but by specification of an area. Specification of the location is performed by the user by operation input by way of the operating unit 12.

Also, specification of genre is performed by eatery, movies, event, amusement facility, and shopping shop as described earlier, with specification thereof also begin performed by user operation input.

Upon the location (area) and genre being specified this way, the terminal device 1 transmits information of the specified location and genre to the server device 2 as indicated by <2>.

At the server device 2, upon the information of the specified location and genre being received form the terminal device 1 side, guide information of a position matching the specified location and satisfying the time-of-day conditions based on the current time-of-day is selected form the guide information of various positions registered in the DB of the specified genre. Specifically, the following guide information selection is performed with regard to guide infuriation of which a position within the specified location (area) has been correlated with, in the specified genre DB.

That is to say, in the event that the specified genre is eatery (hereinafter abbreviated to “eat”), guide information of which the ending time-of-day is later than the current time-of-day is selected from the guide information which has been made an object based on the specified location information from the eatery guide information DB. Accordingly, guide information of eateries within the specified area, excluding guide information of shops which have already closed for the day, can be selected.

Also, in the event that the specified genre is “movie”, guide information is selected for titles correlated with a starting time-of-day later than the current time-of-day from the guide information which has been made an object based on the specified location information from the movie guide information DB. Specifically, information of titles correlated with a starting time-of-day later than the current time-of-day and information of the showing time later than the current time-of-day correlated with the titles, and information of the name of facilities correlated with the title information, are selected. Accordingly, guide information of movie titles shown in facilities within the specified area, excluding guide information of titles regarding which showing has already started and will not be shown again today, can be selected. Consequently, this prevents guide information regarding movie titles which have already started, which is irrelevant guide information, from being selected.

Also, in the event that the specified genre is “event”, guide information of which the ending time-of-day is later than the current time-of-day is selected from guide information made an object based on information of the specified location from the event guide information DB, is selected. Accordingly, guide information of events held within the specified area, excluding guide information of events which have already ended, can be selected.

Also, in the event that the specified genre is amusement facility (hereinafter abbreviated to “play”), guide information of amusement facilities of which the ending time-of-day is later than the current time-of-day is selected from guide information made an object based on information of the specified location from the amusement facility guide information DB, is selected. Accordingly, guide information of amusement facilities within the specified area, excluding guide information of amusement facilities which have already closed for the day, can be selected.

Also, in the event that the specified genre is shopping shops (hereinafter abbreviated to “shopping”), guide information of shops of which the closing time-of-day is later than the current time-of-day is selected from guide information made an object based on information of the specified location from the shop guide information DB, is selected. Accordingly, guide information of shopping shops within the specified area, excluding guide information of shops which have already closed for the day, can be selected.

Thus, upon selecting guide information in accordance with the specified location, genre, and time-of-day conditions, the server device 2 transmits the selected guide information and the position information thereof to the terminal device 1, as indicated in <4>. Accordingly, the selected guide information, and position information correlated with the guide information, are transmitted.

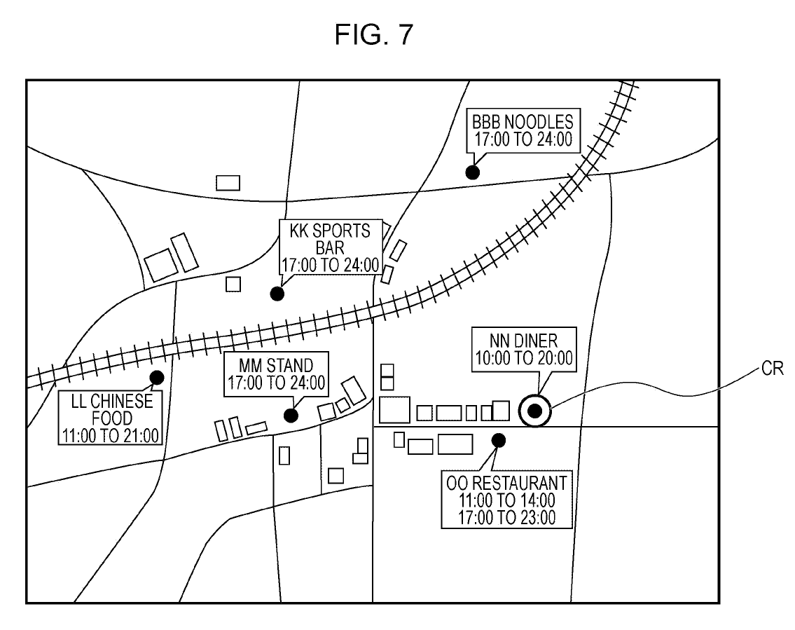

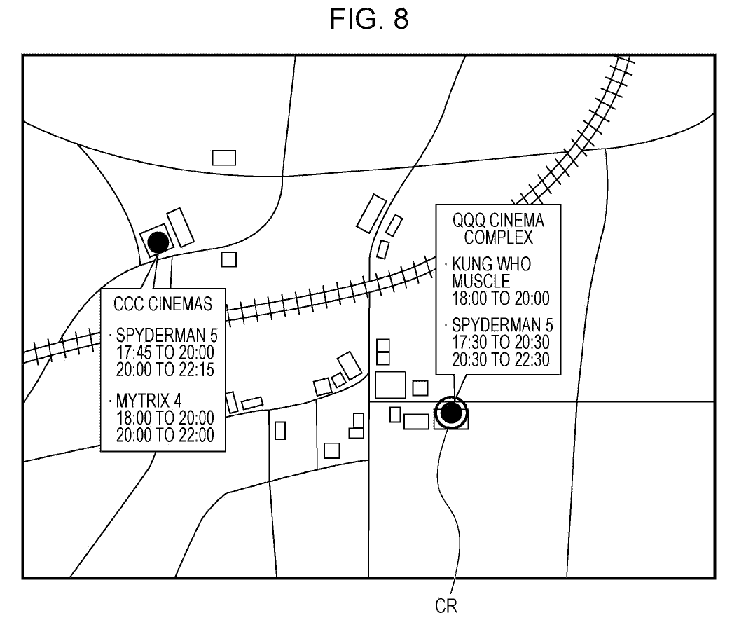

Upon receiving the guide information and position information transmitted from the server device 2, the terminal device 1 performs screen display based on these received information, as indicated by <5>. Specifically, in this case, display is performed with part or all of the selected guide information, and the position correlated with the selected guide information, being presented on a map image, as shown in the following FIGS. 7 and 8.

The terminal device 1 then searches a route to the specified position in response to specification of a position, and starts route navigation, as indicated by the next <6>.

Now, with the guide information presenting system 0 according to the present example, specification of position to be set as a destination is accepted with regard to a position displayed on the map image in <5> above, and in accordance with specification of the position, performs route searching to that position and route navigation. Thus, overall user support of suggesting (guiding) destinations by the above-described guide information selection and display, and route navigation to the specified destination, can be performed.

### Specific Screen Transition Example

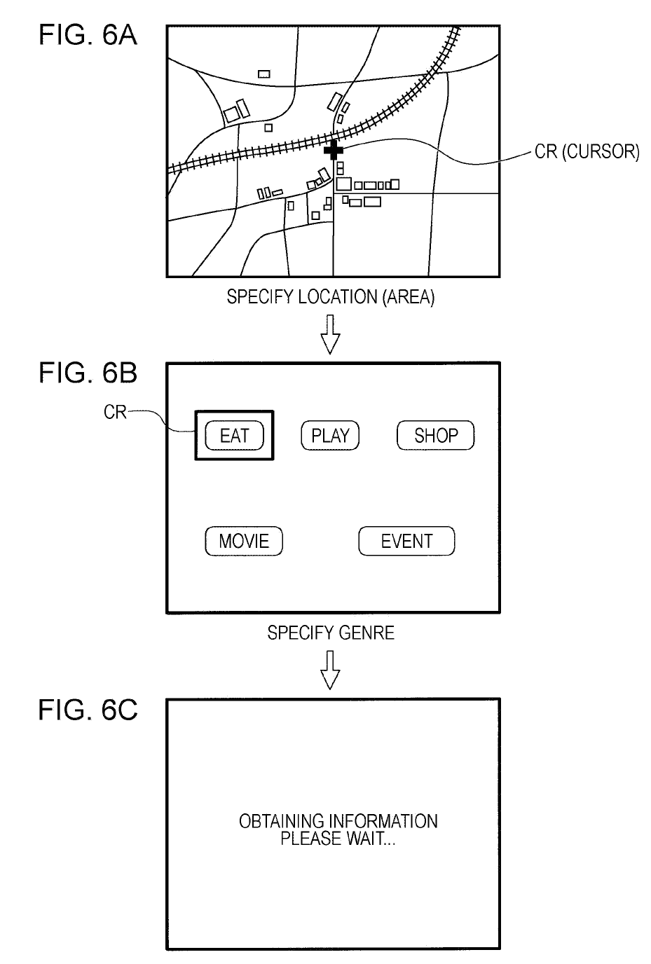

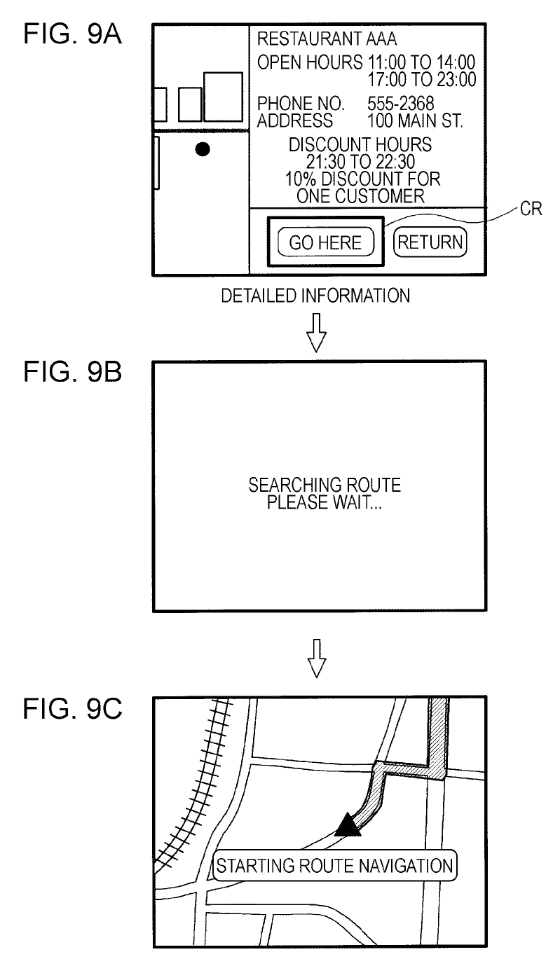

FIGS. 6A through 6C and 9A through 9C illustrate an example of screen transition displayed at the terminal device 1 side in accordance with guide information presenting operations serving as the first embodiment described above.

FIGS. 6A through 6C illustrate screen examples displayed primarily from specification of location to specification of genre, with FIG. 6A illustrating a screen example corresponding to when specifying location, and FIG. 6B illustrating a screen example corresponding to when specifying genre.

The location specification screen shown in FIG. 6A is displayed on the display unit 16 in accordance with an operation input instructing displaying of the location specification screen having been performed as operation input by way of the operating unit 12, for example. Specifically, with this location specification screen, a map image, and a cursor CR at the middle portion thereof, are displayed.

In the state wherein this location specification screen is displayed, the user operates a direction operating element such as a D-pad at the operating unit 12 for example, whereby the map image can be scrolled (with the position of the cursor CR remaining at the middle portion of the screen), whereby the desired area can be displayed within the screen. Input specifying the area displayed on the screen can be performed by operating an OK key at the operating unit 12 for example.

In response to such location specification by user operations, the terminal device 1 displays a genre specification screen illustrated in FIG. 6B on the display unit. With this genre specification screen, icons representing the genres of “eat”, “movie, “event”, “play”, and “shopping”, and a cursor CR for selecting icons of the genres (i.e., for genre selection), are displayed.

In the display state of this genre specification screen, the cursor can be moved and a desired genre selected by the user operating a direction operating element such as a D-pad described above.

Thus, in response to specification of location and genre, the terminal device 1 transmits information of the specified location and the specified genre to the server device 2, and the server device 2 performs selection of guide information and transmission of the selected guide information to the terminal device 1.

At the terminal device 1, an information obtaining screen for informing that information is being obtained from the server device 2 is displayed on the display unit 16 with a form such as shown in FIG. 6C for example, from such specification of location and genre till the transmitted information from the server device 2 is received. With the information obtaining screen in this case, a message such as “obtaining information”, “please wait”, or the like, is displayed as shown in the drawing.

In response to selected guide information and position information correlated with the guide information having been received as transmitted information from the server device 2 side, the terminal device 1 displays information on the display unit 16 such that the received guide information and position information that have been received are presented to the user with a display form of a guide information on-map display screen such as shown in FIGS. 7 and 8.

FIG. 7 illustrates an example of a guide information on-map display screen corresponding to a case wherein the specified genre is “eat”, and FIG. 8 illustrates an example of a guide information on-map display screen wherein the specified genre is “movie”.

With the guide information on-map display screen corresponding to “eat” shown in FIG. 7, marks (icons) indicating positions identified by received position information (i.e., shops in the case of “eat”), and guide information correlated with the position (shop), are displayed on a map image of the specified area. In the event that the genre is “eat”, the guide information on-map display screen displays the shop name information and open hours information as guide information.

With the guide information on-map display screen corresponding to “movie” shown in FIG. 8, marks indicating positions identified by received position information (i.e., movie theaters in the case of “movie”), and guide information correlated with the position, are displayed on a map image of the specified area. In the event that the genre is “movie”, the guide information on-map display screen displays the movie theater, movie titles, and showing times of the movie titles, as guide information.

Here, for the guide information with the genre of “movie”, as described above, the conditions of movie titles being shown in moving theaters within the specified area and with a showing starting time-of-day later than the current time-of-day are set as selection conditions for the server device 2. That is to say, the terminal device 1 side receive transmission from the server device 2 of the names of movie theaters, the titles of movies, and movie showing times after the current time-of-day, for movie titles selected in this way. With a guide information on-map display screen in the case that the genre is “movie”, guide information for each movie title is displayed together for each theater and displayed, as shown in the drawing.

Now, while omitted from the drawings, guide information on-map display screens in the case that other genres are specified will be described as well.

With the genre “event”, in the same way as with the guide information on-map display screen corresponding to “eat” shown in FIG. 7, marks indicating positions identified by received position information (i.e., venues for events in this case), and guide information correlated with the position (venue), are displayed on a map image of the specified area. In the event that the genre is “event”, the guide information on-map display screen displays the contents of the event, and information of open hours, as guide information.

Also, with the genre “play”, in the same way as with the guide information on-map display screen corresponding to “eat” shown in FIG. 7, marks indicating positions identified by received position information (i.e., amusement facilities in this case), and guide information correlated with the position (facility), are displayed on a map image of the specified area. In the event that the genre is “play”, the guide information on-map display screen displays information of the name of the facility, and information of open hours, as guide information.

Also, with the genre “shopping”, in the same way as with the guide information on-map display screen corresponding to “eat” shown in FIG. 7, marks indicating positions identified by received position information (i.e., shops in this case), and guide information correlated with the position (shop), are displayed on a map image of the specified area. In the event that the genre is “shopping”, the guide information on-map display screen displays information of the name of the shop, and information of open hours, as guide information.

For the guide information on-map display screen in this case, in addition to marks indicating the location of the relevant shops or facilities, and guide information, a cursor CR for selecting the position of a shop or facility displayed on the map is also displayed (see FIGS. 7 and 8). With the present embodiment, a more detailed guide information is displayed as a detailed information screen such as shown in the following FIG. 9A, for a position specified by selection with the cursor CR (position icon).

In FIG. 9A, the detailed information screen is displayed in response to a certain position icon being selected by the cursor CR on the guide information on-map display screen such as shown in FIGS. 7 or 8, and an enter operation having been performed in that state. That is to say, this is displayed in response to an operation for specifying a certain position on a guide information on-map display screen.

This detailed information screen displays an enlarged map of the specified position (left side of the screen), guide information correlated with the specified position (at least the same or more items as compared with the displayed items on the guide information on-map display screen), and further a “go here” icon, a “return” icon, and a cursor for selecting from these icons (i.e., the “go here” and “return” items).

FIG. 9A shows an example of a detailed information screen displayed in response to the position of “RESTAURANT AAA” having been specified in the guide information on-map display screen in the case of genre “eat” shown earlier in FIG. 7, as an example. In this case, the guide information includes the name of the shop and open hours, and further discount time information and information of the contents of the discount time. Note that in actual practice, an arrangement would be suitable wherein telephone number information, address information, and so forth, of the shop, are also correlated as to the shop position information, and these information also displayed alongside as shown in the drawing. Now, we will say that the discount hours information and the contents information thereof will not be displayed in the detailed information screen for shops which do not have discount hours or shops which do have discount hours but the ending time time-of-day thereof is earlier than the current time-of-day.

To describe detailed information screens for other genres, as for a case that the genre is “movie”, theater name information correlated with the specified location, the movie title, and showing hours (later than the current time-of-day) thereof, are displayed as guide information on the detailed information screen. Note that in actual practice, an arrangement can be made wherein the plot of the movie, actor names, producer names, and so forth are included as guide information, such that these information can be displayed for each movie title in the detailed information screen.

Also, in the case that the genre is “event”, event content information correlated with the specified position, open hours, and facility name are displayed as the guide information on the detailed information screen, and in the case that the genre is “play”, facility name information correlated with the specified position, open hours, and discount hours and the content information thereof, are displayed as the guide information on the detailed information screen. Now, we will say that with the case of “play” as well, the discount hours information and the contents information thereof will not be displayed in the detailed information screen for facilities which do not have discount hours or facilities which do have discount hours but the ending time time-of-day thereof is earlier than the current time-of-day.

Also, in the case of “shopping”, shop name information correlated with the specified position, open hours, and product genre information are displayed.

In the detailed information screen, one of the “go here” icon, and “return” icon displayed along with each guide information serving as the detailed information can be selected with the cursor CR. The user can select an item from “go here” and “return” by moving the cursor CR between the icons with a direction instructing operating element. The selected item can be specified by performing an enter operation.

Now, the “go here” item is an item for specifying on the guide information on-map display screen and instructing starting of route navigation to the position regarding which detailed information has been displayed (shop or facility). Also, the item “return” is an item for instructing returning from the detailed information screen to the guide information on-map display screen.

In the event that the item “return” has been specified, the display contents on the display unit 16 are returned to those of the guide information on-map display screen.

Also, in the event that the item “go here” is displayed, the route searching screen shown in the following FIG. 9B is displayed, a route search to the specified position. A message such as “searching route”, “please wait” or the like for example, is displayed on the route searching screen.

Upon the route search having been completed, a route navigation start screen shown in FIG. 9C is displayed. With this route navigation start screen, the mark showing the map image including the current position and a mark indicating the current position, and a route to the aforementioned specified position set as the destination (the hatched portion in the drawing) are displayed along with a message such as “starting route guide”, for example, also being displayed. Hereafter, route navigation is performed to the destination, based on route information obtained by searching, and the current position information detected at the position detecting unit.

### Processing Operations

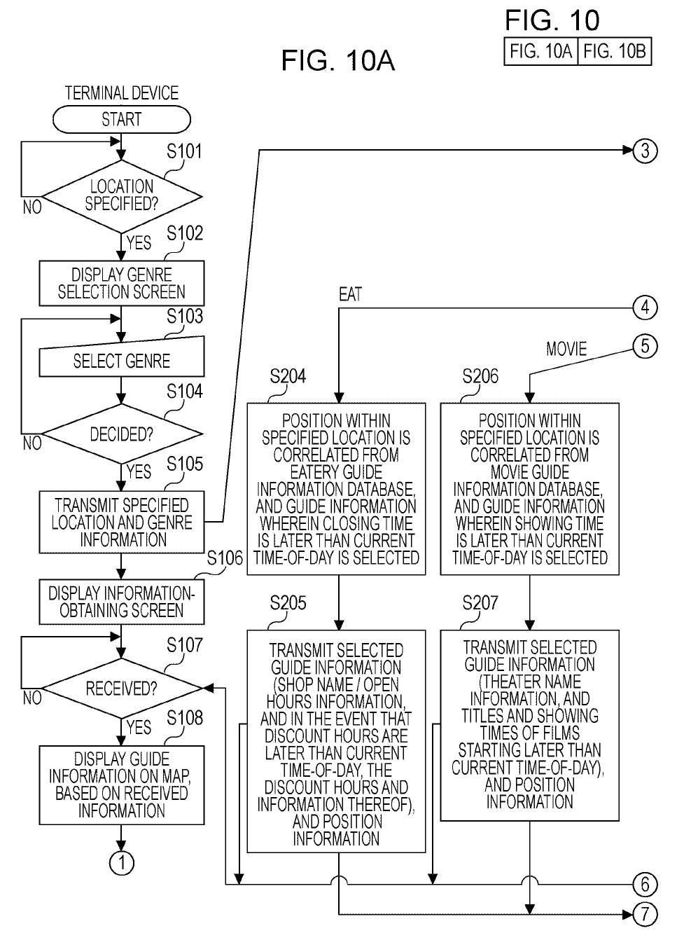

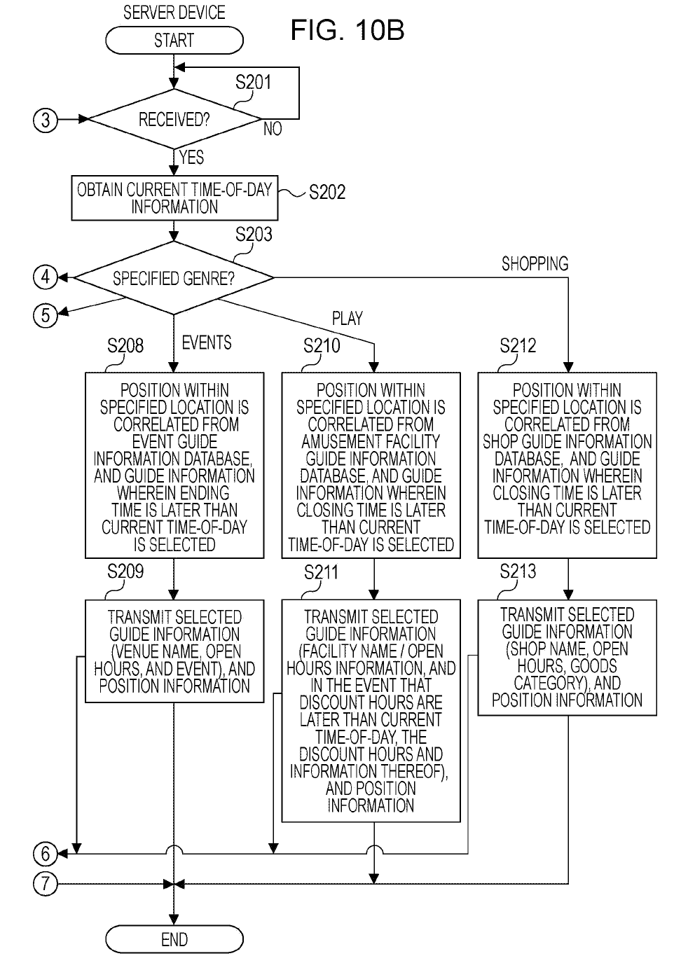

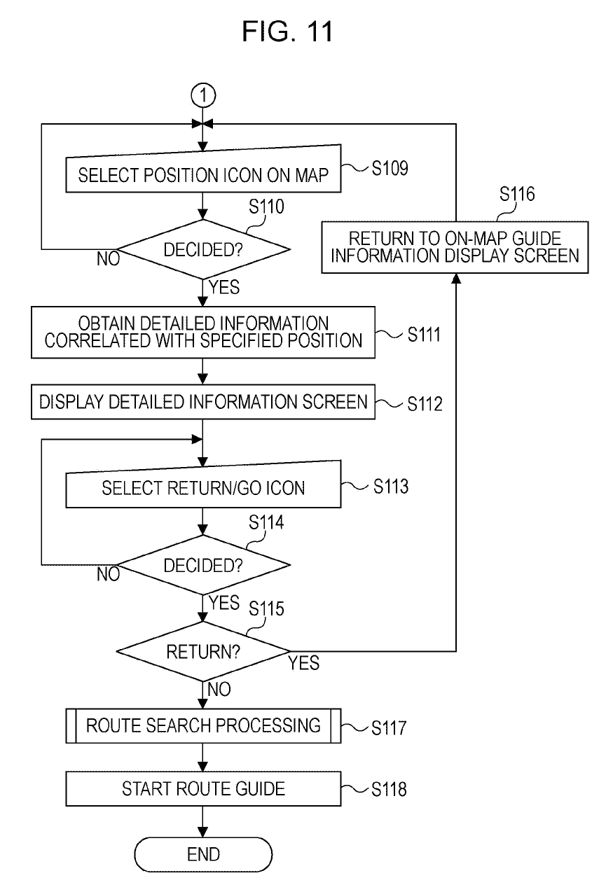

Next, processing operations executed for realizing the operations of the guide information presenting system 0 as the above-described first embodiment will be described with reference to the flowcharts in the following FIGS. 10 and 11. Note that in FIG. 10, the processing operations indicated as “terminal device” are executed based on a program stored in internal ROM for example in the system controller 11 shown in FIG. 2 earlier. Also, the processing operations indicated as “server device” are executed based on a program stored in internal ROM for example in the control unit 21 shown in FIG. 3 earlier.

First, as the processing operations at the terminal device in FIG. 10, in step S101 in the drawing, standby is performed until location specification is performed. That is to say, standby is performed in a display state of a location (area) specification screen such as shown in FIG. 6A earlier, until a deciding operation is performed via the operating unit 12.

In the event that the above deciding operation is performed in step S101 and there has been specification of location, in step S102 display processing is made of the genre selecting screen. That is to say, control is performed so as to display a genre selecting screen shown icons representing each genre and a cursor CR as shown in FIG. 6B on the display unit 16.

The processing in the following steps S103 and S104 is processing for accepting specifications for a certain genre. That is to say, in step S103, processing for moving the cursor CR in accordance with operation input by the direction specifying operating element at the operating unit 12 is executed, thereby causing the user to select a genre. In the following step S104, determination is made regarding whether or not a deciding operation has been performed. In the event that a negative result is obtained in step S104 that a deciding operation has not been performed, the flow returns to step S103 and processing for performing the above-described genre selection is executed.

Also, in the event that a positive result is obtained in step S104 that a deciding operation has been performed, processing is executed in step S105 to transmit the specified location and genre information to the server device 2. That is to say, the area information specified in the earlier step S101 (i.e., information of the area displayed at the time-of-day that the deciding operation has been performed), and the genre information selected and decided (i.e., specified) by the processing in the above steps S103 and S104 are transmitted to the server 2 by the communication unit 15.

Upon executing the transmission processing in this step S105, in step S106 display processing of an information obtaining screen such as shown in FIG. 6C earlier is performed, following which the processing is advanced to the later-described step S107.

At the server device 2 side, standby is performed in step S201 for reception of information transmitted in the above step S105. In the event that the transmitted information from the terminal device 1 side is received by the communication unit 24 in step S201, in step S202, first, obtaining processing is executed for the current time-of-day. That is to say, current time-of-day information clocked by the time-of-day clocking unit 22 is obtained.

In the following step S203, the specified genre is determined. That is to say, determining processing is performed regarding which genre of “eat”, “movie”, “event”, “play”, and “shopping” the specified genre information received from the terminal device 1 side is.

In the event that determination is made in step S203 that the specified genre is “eat”, the processing advances to step S204. In step S204, processing is executed for selecting, from the eatery guide information database, guide information where the position within the specified range is correlated, and also the closing time-of-day is later than the current time-of-day. That is to say, guide information is selected from the eatery guide information database in the guide information database 23a described in FIG. 4 above where position information indicating a position within the specified area is correlated, and also time-of-day information later than the current time-of-day is correlated as information of closing time-of-day, based on the specified location information and specified genre information received in step S201 earlier, and the current time-of-day information obtained in step S202.

In the following step S205, processing is executed for transmitting the selected guide information and position information to the terminal device 1. The above selected guide information is information of the shop name and information of open hours, and for shops where the discount hours ending time-of-day is later than the current time-of-day, the discount hours information and contents information thereof. In step S205, processing is executed for transmitting the selected guide information and the position information correlated with the guide information to the terminal device 1 side by the communication unit 24. Upon the processing in this step S205 being executed, the processing operations at the server device 2 side shown in this drawing end.

Also, in the event that determination is made in step S203 that the specified genre is “movie”, the processing advances to step S206. In step S206, processing is executed for selecting, from the movie guide information database, guide information where the position within the specified range is correlated, and also the showing start time-of-day is later than the current time-of-day. That is to say, guide information is selected from the movie guide information database in the guide information database 23a where position information indicating a position within the specified area is correlated, and also time-of-day information later than the current time-of-day is correlated as information of showing start time-of-day.

In the following step S207, processing is executed for transmitting the selected guide information and position information to the terminal device 1. The above selected guide information in this case is information of titles with a starting time-of-day later than the current time-of-day, information of the name of the facility where the title is shown, and showing times of the title later than the current time-of-day. In step S207, processing is executed for transmitting the selected guide information and the position information correlated with the guide information to the terminal device 1 side by the communication unit 24. Upon the processing in this step S207 being executed, the processing operations at the server device 2 side shown in this drawing end.

Also, in the event that determination is made in step S203 that the specified genre is “event”, the processing advances to step S208. In step S208, processing is executed for selecting, from the event guide information database, guide information where the position within the specified range is correlated, and also the ending time-of-day is later than the current time-of-day. That is to say, guide information is selected from the event guide information database in the guide information database 23a where position information indicating a position within the specified area is correlated, and also time-of-day information later than the current time-of-day is correlated as information of ending time-of-day of the event.

In the following step S209, processing is executed for transmitting the selected guide information and position information to the terminal device 1. The above selected guide information in this case is information of venues, information of open hours, and information of the contents of events. In step S209, processing is executed for transmitting the selected guide information and the position information correlated with the guide information to the terminal device 1 side by the communication unit 24. Upon the processing in this step S209 being executed, the processing operations at the server device 2 side shown in this drawing end.

In the event that determination is made in step S203 that the specified genre is “play”, the processing advances to step S210. In step S210, processing is executed for selecting, from the amusement facility guide information database, guide information where the position within the specified range is correlated, and also the closing time-of-day is later than the current time-of-day. That is to say, guide information is selected from the amusement facility guide information database in the guide information database 23a above where position information indicating a position within the specified area is correlated, and also time-of-day information later than the current time-of-day is correlated as information of closing time-of-day.

In the following step S211, processing is executed for transmitting the selected guide information and position information to the terminal device 1. The above selected guide information is information of the facility name and information of open hours, and for facilities where the discount hours ending time-of-day is later than the current time-of-day, the discount hours information and contents information thereof. In step S211, processing is executed for transmitting the selected guide information and the position information correlated with the guide information to the terminal device 1 side by the communication unit 24. Upon the processing in this step S211 being executed, the processing operations at the server device 2 side shown in this drawing end.

In the event that determination is made in step S203 that the specified genre is “shopping”, the processing advances to step S212. In step S212, processing is executed for selecting, from the shop guide information database, guide information where the position within the specified range is correlated, and also the closing time-of-day is later than the current time-of-day. That is to say, guide information is selected from the shop guide information database in the guide information database 23a above where position information indicating a position within the specified area is correlated, and also time-of-day information later than the current time-of-day is correlated as information of closing time-of-day.

In the following step S213, processing is executed for transmitting the selected guide information and position information to the terminal device 1. The above selected guide information is information of the shop name and information of open hours, and for shops where the discount hours ending time-of-day is later than the current time-of-day, the discount hours information and contents information thereof. In step S213, processing is executed for transmitting the selected guide information and the position information correlated with the guide information to the terminal device 1 side by the communication unit 24. Upon the processing in this step S213 being executed, the processing operations at the server device 2 side shown in this drawing end.

At the terminal device 1 side, standby is performed in step S107 for information transmitted by the transmission processing in the above-described steps S205, S207, S209, S211, or S213.

In step S107, in the event that transmitted information from the server device 2 side is received by the communication unit 15, in step S108 processing for displaying guide information on the map is performed based on the received information. That is to say, control is performed so as to display a guide information on-map display screen such as described earlier with FIGS. 7 and 8 on the display unit 16, based on the received position information and guide information.

As can be understood from the earlier description, in the event that the specified genre is “eat”, on a map image of the specified area are displayed marks (icons) representing the positions identified by the received position information, guide information correlated with the positions (in this case, shop information, and open hours information only), and further the cursor CR for selecting each displayed position (position icon).

Also, in the event that the specified genre is “movie”, on a map image of the specified area are displayed icons representing the positions identified by the received position information, guide information correlated with the positions (in this case, movie theater names, movie titles, and showing time information of the movie titles), and the cursor CR.

Also, in the event that the specified genre is “event”, on a map image of the specified area are displayed icons representing the positions identified by the received position information, guide information correlated with the positions (event content information, and open hours information), and the cursor CR.

Also, in the event that the specified genre is “play”, on a map image of the specified area are displayed icons representing the positions identified by the received position information, guide information correlated with the positions (facilities) (facilities information, and open hours information), and the cursor CR.

Also, in the event that the specified genre is “shopping”, on a map image of the specified area are displayed icons representing the positions identified by the received position information, guide information correlated with the positions (shop name information, and open hours information), and the cursor CR.

Upon the display processing in step S108 being executed, the processing advances to step S109 shown in the next FIG. 11. FIG. 11 illustrates processing operations to be executed at the display device 1 side following the above step S108. In FIG. 11, steps S109 and S110 are processing for accepting position specification for performing display of detailed information from on the map. That is to say, in step S109, processing is executed for moving the cursor CR between position icons in accordance with operations of the direction indicating operating element at the operating unit 12, as processing for selecting a position icon (mark) on the map. Determination is made in the following step S110 regarding whether or not deciding operations have been made via the operating unit 12, and in the event that a negative result is obtained that deciding operations have not been made, the flow returns to step S109 and processing is performed for selecting a position icon from the map.

In the event that a positive result is obtained in step S110 that deciding operations have been made, in step S111 detailed information correlated with the specified position is obtained. That is to say, the detailed information (guide information) correlated with the position on the map selected and decided (specified) by the processing of the above steps S109 and S110 is obtained.

Specifically, in the event that the specified genre is “eat”, shop name information, open hours information, and further in the event that there are discount hours of which the ending time-of-day is later than the current time-of-day, the discount hours information, and information of contents of the discount hours, are obtained as guide information correlated with the specified position.

Also, in the event that the specified genre is “movie”, theater name information correlated with the specified position, and information of movie titles and the showing times (after the current time-of-day), are obtained.

Also, in the event that the specified genre is “event”, event content information correlated with the specified position, open hours information, and venue name information are obtained.

Also, in the event that the specified genre is “play”, amusement facility name information correlated with the specified position, open hours information, and further in the event that there are discount hours of which the ending time-of-day is later than the current time-of-day, the discount hours information, and information of contents of the discount hours, are obtained.

Also, in the event that the specified genre is “shopping”, shop name information correlated with the specified position, open hours information, and product genre, are obtained.

In the following step S112, detailed information screen display processing is performed. That is to say, control is performed so as to display the detailed information obtained in the above step S111, an enlarged map image for the specified position, the icons for “go here” and “return”, and further the cursor CR, on the display unit 16, in a display format such as described earlier with FIG. 9A.

The next steps S113 and S114 are processing for accepting specification of one of the “return” and “go here” icons displayed on the detailed information screen. That is to say, in step S113 the user is caused to select an item of “return”/“go here” by performing processing for moving the cursor CR in accordance with direction instruction operations. In step S114, determination is made regarding whether or not a deciding operation has been performed, and in the event that a negative result is obtained that no deciding operation has been made, the flow returns to step S113.

In the event that a positive result is obtained in step S114 that a deciding operation has been made, in step S115 determination is made regarding whether or not the decided (specified) icon is the “return” icon. In the event that a positive result is obtained in step S115 that the decided (specified) icon is the “return” icon, in step S116 processing is executed for returning the displayed contents on the display unit 16 to the guide information on-map display screen, following which the flow returns to the earlier step S109. Thus, the user can redo specification of the position on the guide information on-map display screen by inputting specification of “return”.

On the other hand, in the event that a negative result is obtained in step S115 that the specified icon is not the “return” icon (i.e., in the event that the “go here” icon has been specified), in step S117 route searching processing is started. That is to say, route searching to the destination is performed with the position specified in the earlier steps S109 and S110 as the destination and the current position obtained by the position detecting unit 13 as the starting position. Note that in this case, display processing of a route searching screen such as shown in the earlier FIG. 9B is also executed, while searching for a route.

In the following step S118, processing for starting route navigation is started. That is to say, based on route information obtained in the route searching processing in the above step S117, control is performed such that a route navigation start screen such as shown in the earlier FIG. 9C is displayed on the display unit 16, and also route navigation to the destination is started based on the route information obtained above and the current position information detected at the position detecting unit 13. Upon executing the processing of this step S118, the processing operation at the terminal device 1 side shown in this diagram ends.

### Summarization

As described so far, with the guide information presenting system 0 according to the first embodiment, guide information includes time-of-day information relating to things which are the object of guiding, and this time-of-day information is used to select and present guide information satisfying time-of-day conditions based on the current time-of-day, from guide information correlated with positions corresponding to a specified location. More specifically, guide information is selected wherein the time-of-day, indicated by time-of-day information to be included in the guide information, is the current time-of-day or later.

Accordingly, the displayed guide information can be narrowed down to only guide information, of those corresponding to the specified location, wherein time-of-day conditions in which the above object time-of-day is the current time-of-day or later. For example, in the event that the guide information is guide information regarding a shop of facility including open house information (starting time-of-day to ending time-of-day), the open hours ending time-of-day being the current time-of-day or later is a condition for the above time-of-day conditions, whereby only guide information regarding shops and facilities that are open is displayed. That is to say, in this way, display of irrelevant guide information regarding shops and facilities that have already closed for the day can be prevented.

Alternatively, in the event that the guide information is movie showing guide information including showing times for each title for example, the showing starting time-of-day being the current time-of-day or later is a condition for the above time-of-day conditions, whereby only guide information regarding movies which can still be watched is displayed. That is to say, in this way, display of irrelevant guide information regarding movies that have already started can be prevented.

Thus, according to the first embodiment, an arrangement can be made wherein only relevant guide information is displayed with the current time-of-day as a reference. Accordingly, limited display space can be efficiently used at the time of presenting guide information.

Also, displaying only relevant guide information means that irrelevant information does not get in the way when searching for a desired position (e.g., position to be set as a destination), as with the related art.

### Second Embodiment

Next, a second embodiment will be described. The second embodiment is an arrangement wherein an arrangement which had been arranged to set time-of-day conditions based only on the current time-of-day with the first embodiment has been arranged to set time-of-day conditions based on the current time-of-day and further the required time to arrival.

With the second embodiment as well, the components of the system are the same as with those shown in FIG. 1 earlier, so description thereof will be omitted. Also, the configurations of the terminal device 1 and server device 2 are the same as those described with the first embodiment (FIGS. 2 and 3) other than the processing operations executed by the respective system controller 11 and control unit 21 being different (i.e., the program being different), so description thereof will be omitted.

### Overview of Operations

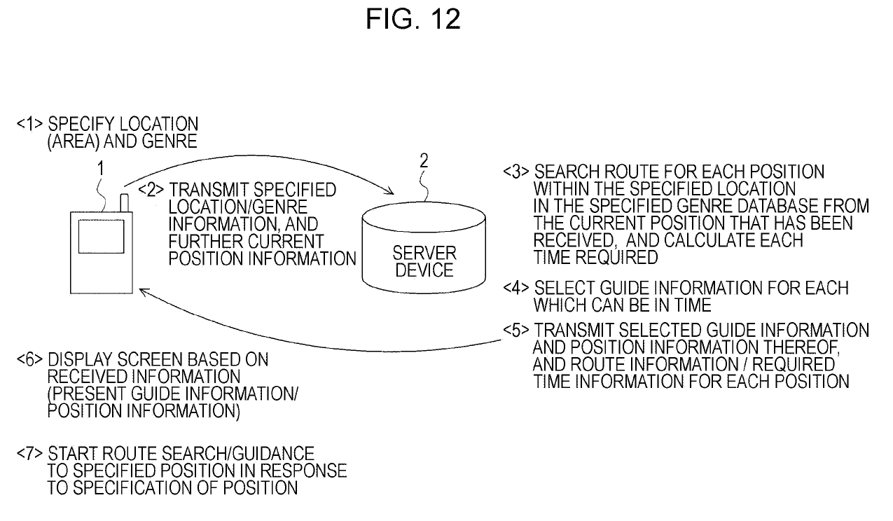

FIG. 12 is a diagram schematically illustrating the overview of guide information presenting operations performed at the guide information presenting system 0 serving as the second embodiment. Note that the network 3 is also omitted in this FIG. 12. In FIG. 12, at the terminal device 1 in this case as well, first specification of the location (area) and specification of genre are performed as <1> in the drawing. Note that with the second embodiment as well, the screen displayed corresponding to the time of specification of the area and genre are the same as that exemplarily illustrated earlier in FIGS. 6A through 6C.

With the terminal device 1 according to the second embodiment, in response to specification of the area and genre having been performed, further current position information is transmitted to the server device 2 along with the specified area and genre, as <2> in the drawing.

With the server device 2 in this case, upon receiving the specified area and genre, and the current position (terminal current position) information which the terminal device 1 has transmitted, route searching from the received current location to each position within the specified location (area) in the database of the specified genre, and calculation of required time for each, are performed. That is to say, route searching from the terminal current location to each position within the specified area in the database of the specified genre, and calculation of required time to reach each position from the terminal current position, are performed.

In the following <4>, guide information is selected based on those which can be reached in time including the required time, based on information of the required time to each location obtained as described above. That is to say, a time-of-day is obtained as an arrival time-of-day by adding the required time to each object position within the specified location in the database of each genre, and also guide information where the object time-of-day information is the arrival time-of-day or later is selected from the guide information correlated to each of the object positions.

Specifically, in the event that the specified genre is “eat”, of the guide information in the eatery guide information database correlated with positions within the specified location, the guide information (shop name information, open hours information, discount hours information and content information thereof) wherein the closing time-of-day is current time-of-day+required time=estimated arrival time-of-day or later, is selected.

Note that in this case, discount hours information and content information thereof of which the ending time-of-day is not the estimated arrival time-of-day or later is omitted from the objects of selection.

Also, in the event that the specified genre is “movie”, of the guide information in the movie guide information database correlated with positions within the specified location, the guide information (title name information, movie theater name information, showing time information (estimated arrival time-of-day or later)) wherein the showing start time-of-day is the estimated arrival time-of-day or later, is selected.

Also, in the event that the specified genre is “event”, of the guide information in the event guide information database correlated with positions within the specified location, the guide information (event content information, open hours information, venue name information) wherein the ending time-of-day is the estimated arrival time-of-day or later is selected.

Also, in the event that the specified genre is “play”, of the guide information in the amusement facility guide information database correlated with positions within the specified location, the guide information (facility name information, open hours information, discount hours information and content information thereof) wherein the ending time-of-day is the estimated arrival time-of-day or later is selected.

Note that in the case of the genre “play” as well, discount hours information and content information thereof of which the ending time-of-day is not the estimated arrival time-of-day or later is omitted from the objects of selection.

Also, in the event that the specified genre is “shopping”, of the guide information in the shop guide information database correlated with positions within the specified location, the guide information (shop name information, open hours information, product genre information) wherein the closing time-of-day is the estimated arrival time-of-day or later is selected.

Upon guide information being selected in this way based on specified genre and specified location information, and estimated arrival time-of-day information, the selected guide information and the position information thereof, route information to each position and required time information, are transmitted to the terminal device 1 side, as shown in the following <5>.

That is to say, the selected guide information and the position information correlated with the guide information, and further the route information to each position and the required time information, are transmitted to the terminal device 1.

At the terminal device 1 side, screen display based on the received information is performed. A guide information on-map display screen such as described earlier with FIGS. 7 and 8 is displayed as the display based on the received information, in this case as well. Accordingly, presentation of the selected guide information and position information is performed. Note that in this case as well, the contents of guide information displayed on the guide information on-map display screen is the same as with the case of the first embodiment.

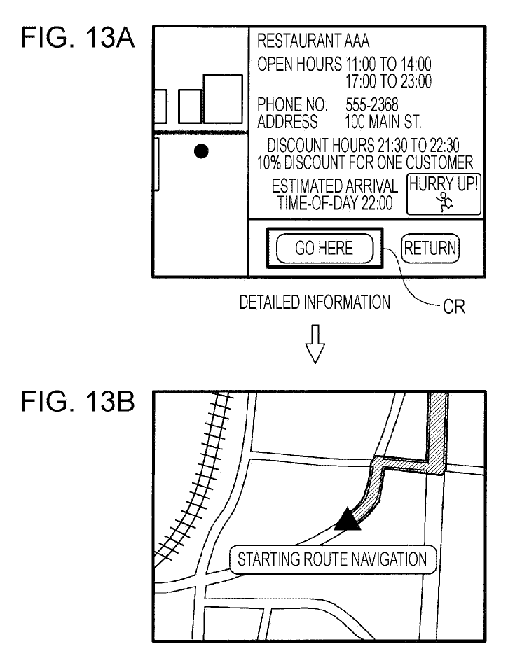

After performing display of the received information, route navigation based on the received route information is started in accordance with specification of position, as shown in <7>. In this case as well, specification or each position displayed on the map screen is accepted following displaying of the guide information on-map display screen, and in the event that a position is specified, first a detailed information screen is displayed. Note however, with the detailed information screen in this case, information of the estimated arrival time-of-day is also displayed as shown in the following FIG. 13A.

In FIG. 13A, an example of a detailed information screen displayed corresponding to a case where the position of the “RESTAURANT ΔO” has been specified on the guide information on-map display screen, in the same way as with the case in the earlier FIG. 9A, is shown as an example.

As can be understood from this screen display example as well, with the detailed information screen according to the second embodiment, in addition to the detailed information screen according to the second embodiment, information of the estimated arrival time-of-day is also displayed. This estimated arrival time-of-day can be obtained based on the required time to the specified position of the information of required times received from the server device 2 side (i.e., in the example in FIG. 13A, the required time to the position of the “RESTAURANT AAA”), and the current time-of-day information. Specifically, this can be obtained by adding the required time to the specified location, to the current time-of-day.

While description by way of drawings has been omitted, with the terminal device 1 in this case, the system controller 11 has a time-of-day clocking function, and the current time-of-day can be obtained by this clocking function.

Also, with the detailed information screen in this case, in the event that the time difference between the time-of-day serving as the object within the guide information and the estimated arrival is small, i.e., in the event that the estimated arrival time-of-day is predicted to be barely on time for the object time-of-day, a “Hurry Up” mark such as shown in the drawing is also displayed. With this “Hurry Up” mark, information display to the effect that there is no leeway in time to the object time-of-day from the arrival time-of-day is performed, such as a message “Hurry Up” or an icon depicting a person running, for example. Note that the “object time-of-day in the guide information” is the closing time-of-day in the case that the genre is “eat”, “play”, or “shopping”, is showing start time-of-day in the case of “movie”, and is the ending time-of-day in the case of “event”.

By performing display of such a “Hurry Up” mark, the user can be accurately notified that there is little leeway in time from the arrival to closing time-of-day of the shop of closing or closing of a park, or ending time-of-day of an event, or that there is little leeway in time to the starting time-of-day of showing of a movie. That is to say, a more excellent system can be provided from this point.

In the event that the “return” icon is specified with selection by the cursor CR in such a detailed information screen, the display contents of the display unit 16 are returned to the guide information on-map display screen in this case as well.

On the other hand, in the event that the “go here” icon is specified, the route navigation start screen is displayed as shown in the following FIG. 13B. That is to say, route information to each position has already been received in this case, so route searching processing to the specified position does not have to be performed at the terminal device 1 side. Accordingly, the route searching screen such as shown in FIG. 9B earlier is not inserted in response to specification of the “go here” icon, and the route navigation start screen is displayed.

With the guide information presenting system 0 according to the second embodiment described above, guide information can be selected taking into account the required time to arrival, so only guide information for shops, facilities, movies, events, and so forth, which the user can be expected to reach in time even after traveling from the present time, can be presented.

Also, with the second embodiment, the route information to each position is obtained at the server device 2 side, since calculation of the required time is being executed at the server device 2 side. Accordingly, the route information obtained at the server device 2 side is transmitted to the terminal device 1 side. Thus, the terminal device 1 side does not have to perform route searching processing in order to perform route navigation to the specified position, and the processing load required for route navigation can be accordingly alleviated as compared with the case of the first embodiment. Portable use of the terminal device 1 is assumed, meaning that being driven by battery power is a prerequisite. Accordingly, reduction in processing load leads to extended continuous driving time due to reduction in consumption of electricity.

### Processing Operations

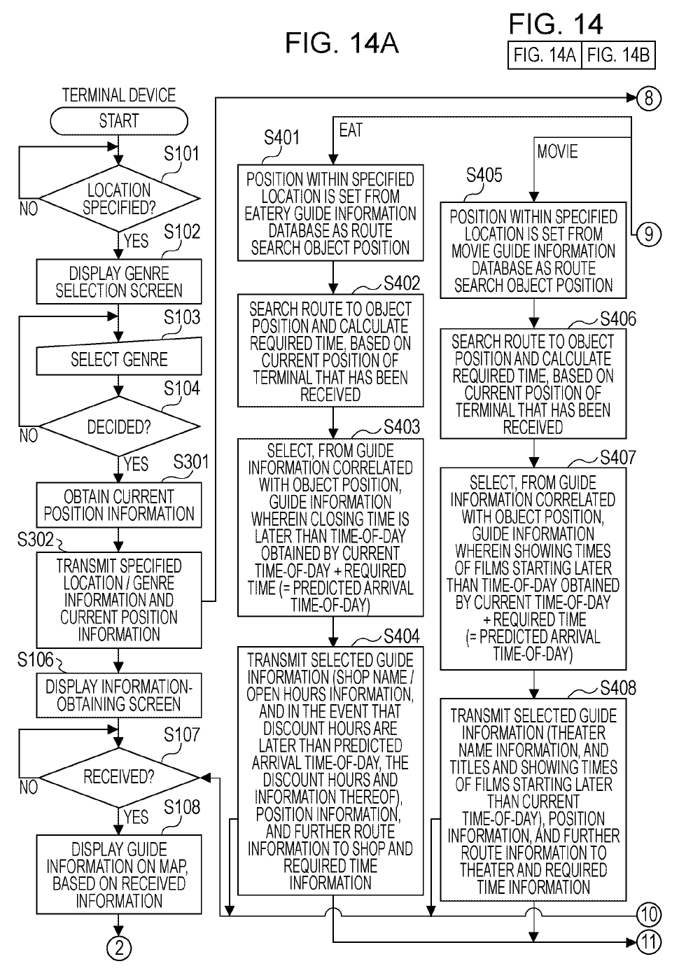

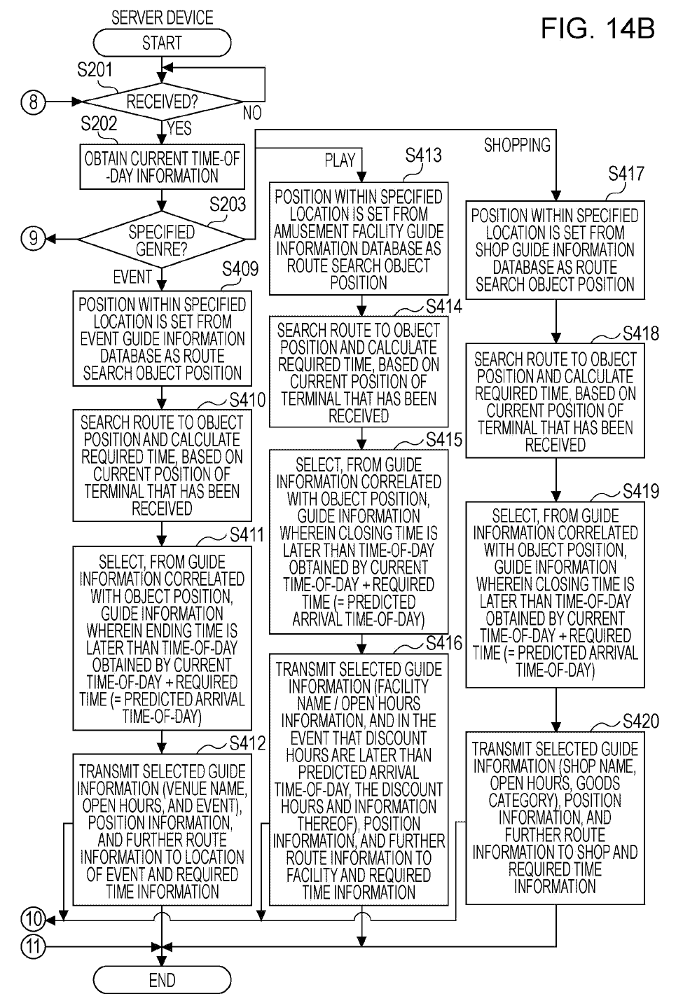

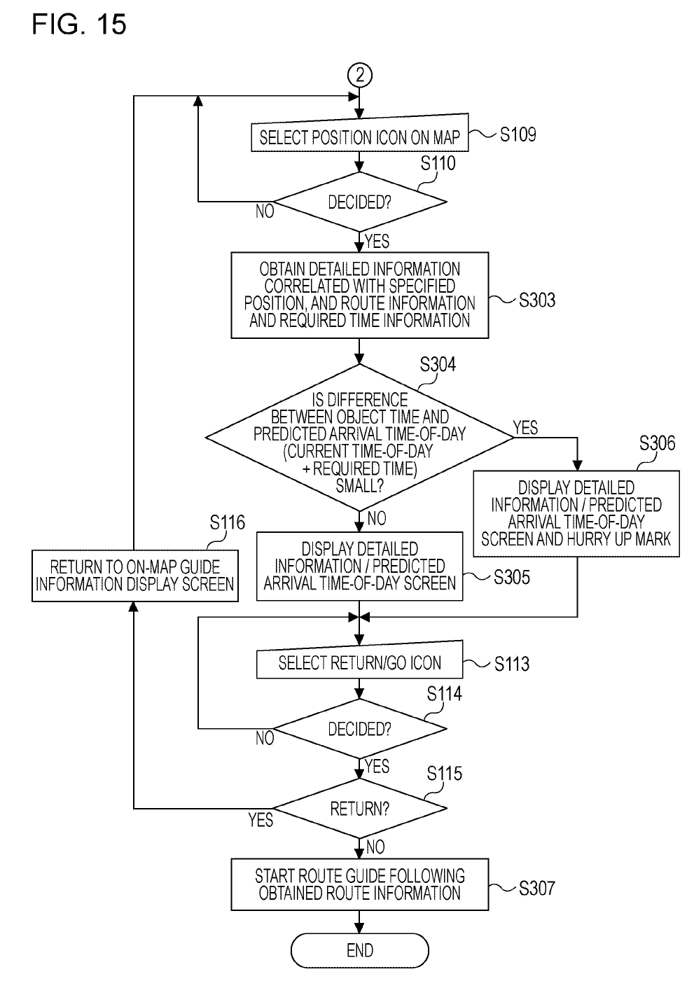

The flowcharts in FIGS. 14 and 15 illustrate processing operations to be executed for realizing operations as the guide information presenting system 0 as the above-described second embodiment. In this case as well, processing operations indicated as terminal device in the drawings are executed based on a program stored in internal ROM for example in the system controller 11 shown in FIG. 2 earlier, and also, the processing operations indicated as server device are executed based on a program stored in internal ROM for example in the control unit 21 shown in FIG. 3 earlier.

Now as can be understood from the earlier operation overview description, the second embodiment partially executes processing the same as the case of the first embodiment. In order to facilitate description there, the processing operations which are the same in content as the case of the first embodiment are denoted with the same step numbers. Here, redundant description of processing operations which are the same as with the case of the first embodiment is avoided, and description is primarily made regarding processing operations of portions which differ from the case of the first embodiment.

First, the processing operations as far as steps S101 through S104 in the drawing as the processing operations of the terminal device 1 side shown in FIG. 14 are the same as the processing with the same step numbers described earlier with FIG. 10. That is to say, location (area) specification and genre specification are accepted by the series of processing.

In this case, in the event that a positive result is obtained in step S104 that a deciding operation has been performed, current position information obtaining processing is performed in step S301 in the drawing. That is to say, the current position information (terminal position information) is obtained by the position detecting unit 13.

In the following step S302, processing for transmitting the specified location and genre and the current position information to the server device 2 side is executed as transmission processing. That is to say, control is performed such that the location information and genre information regarding which specification has been accepted in the processing of steps S101 through S104 and further the current position information obtained in step S301 are transmitted to the server device 2 side by the communication unit 15. Upon executing transmission processing to the server device 2 in step S302, in step S106 information obtaining screen display processing is executed, following which the flow advances to step S107.

At the server device 2 side, standby is performed in step S201 for reception of information transmitted in the above step S302. In the event that the transmitted information is received by the communication unit 24, in step S202, obtaining processing is executed for the current time-of-day, and in the following step S203, the specified genre is determined.

In the event that determination is made in step S203 that the specified genre is “eat”, the processing advances to step S401.

In step S401, from the eatery guide information database, positions are set as route search object positions within the specified region.

In the following step S402, routes are searched to the object positions from the received terminal current position, and also calculation of required time is performed. That is to say, route searching is performed from the terminal current position which the current position information received from the terminal device 1 in step S201 indicates, to each position set as route search object positions in step S401, and information of required time to the route searching object positions according to the obtained routes is obtained.

Further, in the next step S403, of the guide information correlated with the object positions, guide information wherein the closing time-of-day is a time-of-day obtained by current time-of-day+required time (estimated arrival time-of-day) or later is selected. That is to say, guide information is selected from the eatery guide information database wherein, of guide information correlated with the position information serving as the route searching object position, the closing time-of-day is the above estimated arrival time-of-day or later.

In the following step S404, processing is executed for transmitting, to the terminal device 1, the selected guide information (information of the shop name and information of open hours, and for shops where the discount hours ending time-of-day is later than the estimated arrival time-of-day, the discount hours information and contents information thereof), and position information correlated with the selected guide information, and further route information to the shop and required time information. Upon the processing in this step S404 being executed, the processing operations at the server device 2 side shown in this drawing end.

Also, in the event that determination is made in step S203 that the specified genre is “movie”, the processing advances to step S405.

In step S405, from the movie guide information database, positions are set as route search object positions within the specified region.

In the following step S406, routes are searched to the object positions from the received terminal current position, and also calculation of required time is performed.

Further, in step S407 following step S406, of the guide information correlated with the object positions, guide information wherein the showing start time-of-day is a time-of-day obtained by current time-of-day+required time (estimated arrival time-of-day) or later is selected.

In the next step S408, processing is executed for transmitting, to the terminal device 1, the selected guide information (information of the theater name, titles to be shown later than the estimated arrival time-of-day and information of showing time of the title after the estimated arrival time-of-day), and position information correlated with the selected guide information, and further route information to the theater and required time information. Upon the processing in this step S408 being executed, the processing operations at the server device 2 side shown in this drawing end.

Also, in the event that determination is made in step S203 that the specified genre is “event”, the processing advances to step S409.

In step S409, from the event guide information database, positions are set as route search object positions within the specified region.

In the following step S410, routes are searched to the object positions from the received terminal current position, and also calculation of required time is performed.

Further, in the following step S411, of the guide information correlated with the object positions, guide information wherein the closing time-of-day is a time-of-day obtained by current time-of-day+required time (estimated arrival time-of-day) or later is selected.

In the next step S412, processing is executed for transmitting, to the terminal device 1, the selected guide information (information of name of the venue, open hours, and information of contents of the event), and position information correlated with the selected guide information, and further route information to the theater and required time information. Upon the processing in this step S412 being executed, the processing operations at the server device 2 side shown in this drawing end.

Also, in the event that determination is made in step S203 that the specified genre is “play”, the processing advances to step S413.

In step S413, from the event guide information database, positions are set as route search object positions within the specified region.

In the following step S414, routes are searched to the object positions from the received terminal current position, and also calculation of required time is performed.

Further, in the following step S415, of the guide information correlated with the object positions, guide information wherein the closing time-of-day is a time-of-day obtained by current time-of-day+required time (estimated arrival time-of-day) or later is selected.

In the next step S416, processing is executed for transmitting, to the terminal device 1, the selected guide information (information of the facility name and information of open hours, and for facilities where the discount hours ending time-of-day is later than the estimated arrival time-of-day, the discount hours information and contents information thereof), and position information correlated with the selected guide information, and further route information to the facility and required time information. Upon the processing in this step S416 being executed, the processing operations at the server device 2 side shown in this drawing end.

Also, in the event that determination is made in step S203 that the specified genre is “shopping”, the processing advances to step S417.

In step S417, from the event guide information database, positions are set as route search object positions within the specified region. In the following step S418, routes are searched to the object positions from the received terminal current position, and also calculation of required time is performed.

Further, in the following step S419, of the guide information correlated with the object positions, guide information wherein the closing time-of-day is a time-of-day obtained by current time-of-day+required time (estimated arrival time-of-day) or later is selected.

In the next step S420, processing is executed for transmitting, to the terminal device 1, the selected guide information (shop name information, open hours information, product genre information), and position information correlated with the selected guide information, and further route information to the shop and required time information. Upon the processing in this step S420 being executed, the processing operations at the server device 2 side shown in this drawing end.

At the terminal device 1 side, standby is performed in step S107 for information transmitted by the transmission processing in the above-described steps S404, S408, S412, S416, or S420.

In step S107, in the event that transmitted information from the server device 2 side is received by the communication unit 15, in step S108 processing for displaying guide information on the map is performed based on the received information. That is to say, in this case as well, control is performed so as to display a guide information on-map display screen such as with the case of the first embodiment above, on the display unit 16, based on the received position information and guide information.

Upon the display processing in step S108 being executed, the processing advances to step S109 shown in FIG. 15.

FIG. 15 illustrates processing operations to be executed at the display device 1 side following the above step S108. In FIG. 15, in this case as well, step S109 and step S110 are processing for accepting position specification for performing display of detailed information from on the map, in the same way as with the first embodiment.

That is to say, in this case, in the event that a positive result is obtained in step S110 that deciding operations have been made, in step S303 detailed information correlated with the specified position, and further route information and required time information, are obtained. That is to say, the detailed information (guide information) correlated with the position on the map selected and decided (specified) by the processing of the above steps S109 and S110, and route information and required time information, are obtained.

In the following step S304, determination is made regarding whether or not the difference between the object time-of-day and the estimated arrival time-of-day (current time-of-day+required time) is small. That is to say, the estimated arrival time-of-day is first calculated based on the required time information obtained in step S303 and the current time-of-day clocked by itself, and the time difference between the estimated arrival time-of-day and the object time-of-day (the closing time-of-day in the case that the genre is “eat”, “play”, or “shopping”, showing start time-of-day in the case of “movie”, and the ending time-of-day in the case of “event”). Thereupon, determination is made regarding whether or not the value of the obtained time difference is at or lower than a predetermined threshold value th-t.

In the event that determination is made in step S304 that the value of the obtained time difference is not at or lower than the predetermined threshold value th-t, and that the difference between the estimated arrival time-of-day and the object time-of-day is not small, the flow proceeds to step S305, and screen display is performed of detailed information and estimated arrival time-of-day. That is to say, control is performed such that a detailed information screen showing the information of the estimated arrival time-of-day calculated in the above step S304 is displayed on the display unit 16 as a detailed information screen presenting the detailed information obtained in step S303.

On the other hand, in the event that determination is made in step S304 that the value of the obtained time difference is at or lower than the predetermined threshold value th-t, and that the difference between the estimated arrival time-of-day and the object time-of-day is small, the flow proceeds to step S306, and screen display is performed of detailed information and estimated arrival time-of-day, and the “Hurry Up” mark. That is to say, control is performed such that a detailed information screen showing the information of the estimated arrival time-of-day calculated in the above step S304, and the “Hurry Up”mark such as described earlier in FIG. 13A, are displayed on the display unit 16 as a detailed information screen presenting the detailed information obtained in step S303.

Upon performing the processing of step S305 or step S306 above, processing for accepting specification of a “return”/“go here” icon, and determination processing of whether the specified icon is the “return” icon, is performed by the processing in steps S113, S114, and S115.

In this case as well, in the event that a positive result is obtained in the above step S115 that the specified icon is the “return” icon, the flow advances to step S116 and processing for returning the display contents of the display unit 16 to the guide information on-map display screen is performed, following which the flow returns to step S109.

On the other hand, in the event that a negative result is obtained in step S115 that the specified icon is not the “return” icon, the flow proceeds to step S307, and route navigation following the obtained route information is started. That is to say, control is performed such that a route navigation starting screen such as shown in FIG. 13B (FIG. 9C) above is displayed on the display unit 16 based on the route information to the specified position obtained in step S303 earlier, and also route navigation to the destination is started based on the obtained route information and the current position information detected by the position detecting unit 13.

Upon executing the processing of step S307, the processing operations of the terminal device 1 shown in this drawing end.

### Modifications

While embodiments of the present invention have been described above, the present invention should not be restricted to specific example described so far. For example, with the guide information presenting system according to the present invention, a configuration may be made wherein selection of guide information based on time-of-day conditions is performed at the terminal device side.

As one example, a configuration can be given wherein the terminal device side downloads the information contents of a guide information database constantly updated at a server device side, at a certain cycle such as once a day, and guide information is selected based on the downloaded information contents. Note that the above downloading can be realized by the communication unit 15 being controlled by the system controller 11 so as to periodically obtain the information contents of the guide information database 23a stored at the server device 2.

In this case, in the event of taking the current time-of-day as the reference time-of-day as with the first embodiment, the terminal device side selects guide information from the guide information database based on the specified location and genre information, and the current time-of-day which it itself clocks. Or, in the event that the reference time-of-day is the current time-of-day+required time=estimated arrival time-of-day as with the second embodiment, the terminal device can first set route search object positions based on the specified location and genre information, and then select guide information based on the results of the estimated arrival time-of-day having been obtained by performing rout searching to the object positions and calculation of the required time.

Also, the genres of guide information exemplarily illustrated in the description so far are only examples, and the present invention can also be suitably applied to cases with other genres of guide information, as a matter of course.

Alternatively, genres can be set wherein the exemplarily illustrated genres are further subdivided. For example, in the genre of “eat”, subdivisions of Japanese/Italian/Chinese . . . and so forth can be made.

Also, with the description so forth, examples have been illustrated where only specification of one type of genre specification is accepted, but an arrangement may be made wherein specification of multiple genres is accepted, and selection and display of guide information is performed for each of the specified genres.

Alternatively, this can be suitably applied to a system wherein there is no genre dividing of guide information. For example, this can be conceivably used as a guide information presenting system dedicated to eateries, movies, or the like.

Also, while description has been made so far with an example of a case of displaying guide information satisfying conditions, and position information thereof, on a map image, the display format of the guide information and position information should not be restricted to this. For example, guide information and position information can be formed into a list and displayed as a list.

Also, while description has been made so far with an example of a case of specifying a location by specifying an area, a position can be specified for location specification. As one example, a system can be made wherein specification of the position of a desired movie theater is accepted for the genre “movie” for example, and guide information of titles to be shown at this movie theater from now on is presented.

Also, while description has been made so far with an example of a case of specifying a location using a map, specification can be made by text input. For example, text input for specifying areas, such as “SoHo”, “Upper East Side” and so on, for example, can be accepted.

Also, with the second embodiment, while description has been made regarding an arrangement wherein only one route is obtained in route searching, and calculation of required time information is obtained for only one route accordingly, an arrangement may be made wherein multiple routes are obtained by traffic means available of reaching the destination, and the required time (estimated arrival time-of-day) is obtained for each route. In this case, estimated arrival time-of-day information is presented for each route in the detailed information screen, and specification is accepted for the actual route for navigation from these routes.

Also, while description has been made so far with an example of a case of the object time-of-day in the guide information being the reference time-of-day or later, as time-of-day conditions for selection of guide information, a predetermined offset may be set for the reference time-of-day. For example, in the case of the first embodiment, the reference time-of-day may be the current time-of-day+30 minutes, or with the case of the second embodiment, this may be the estimated arrival time-of-day+10 minutes, and so forth.

Also, in the event of providing an offset to the current time-of-day or estimated arrival time-of-day in this way, the value of the offset may be variably set. Providing such a variable offset with the first embodiment will allow for advantages the same as with the case of the second embodiment, by calculating general required time for arrival based on the results of calculating the distance form the current position to the specified place (area or location), and adding an offset value based on the value of the required time to the current time-of-day value. Note that the offset value in this case is variably set in accordance with the general required time value that is calculated.

Also, with the second embodiment, the offset value is variably set based on user operations, for example. Accordingly, adjustment can be made such as selecting and displaying only guide information for those which can be reached with leeway in time, or selecting and displaying guide information even for those which can only be reached at the last minute.

Also, while description has been made so far regarding an arrangement wherein, of guide information correlated with a position corresponding to a specified location, guide information not satisfying the time-of-day conditions and the position information thereof are not displayed, but an arrangement may be made wherein the guide information and position information not satisfying the conditions in this way are displayed in an inactive state. For example, an inactive state may be displaying the color darkness of the icon in a lighter manner or displaying in monochrome while other active icons are displayed in color, or the like, and further disabling selection (specification) of the displayed icon, or the like.

Also, description has been made so far with an example of a case of guide information including separate time-of-day information from the direct object time-of-day information, such as discount hours, not being presented as guide information if the time-of-day conditions are applied and the ending time-of-day is not at or later than the reference time-of-day, but an arrangement may be made wherein guide information including time-of-day information which is not directly the object time-of-day information is presented even if not at or later than the reference time-of-day.

Also, description has been made so far regarding an arrangement wherein the entire map image serving as the map database 14a is stored within the terminal device, but the map image can be downloaded via the network 3 as suitable and used.

Also, image information can be used wherein an aerial photograph for example is substituted for the map image.

It should be understood by those skilled in the art that various modifications, combinations, sub-combinations and alterations may occur depending on design requirements and other factors insofar as they are within the scope of the appended claims or the equivalents thereof.

What is claimed is:

1. A guide information providing system which is configured so as to include a terminal device, and a server device, comprising:
specified location acceptance means, provided in said terminal device, configured to accept input of a specified location;
display means, which are provided in said terminal device, configured to display information;
storing means, provided in said server device, configured to store guide information classified by position wherein guide information including time-of-day information, and position information, of a thing which is the object of guiding, are correlated;
information selecting means configured to select guide information which is correlated with position information indicating the position corresponding to said specified location based on the content of specified location information of which the input has been accepted by said specified location acceptance means, and said guide information classified by position, and satisfies a time-of-day condition with at least the current time-of-day and thereafter as reference; and
display control means, which are provided in said terminal device, configured to control said display means to provide the guide information selected by said information selecting means, and position information correlated with the guide information thereof to a user in a predetermined display format.

2. The guide information providing system according to claim 1, wherein said specified location acceptance means accept input of a specified area as said input of a specified location;
and wherein said information selecting means perform selection of guide information with guide information which is correlated with position information indicating a position within a specified area of which the input has been accepted by said specified location acceptance means as a target.

3. The guide information providing system according to claim 2, further comprising:
position detecting means, provided in said terminal device, configured to detect the current position of the relevant terminal device; and
time-distance calculating means configured to calculate time distance from the current position of said terminal device detected by said position detecting means to the position corresponding to said specified location in said guide information classified by position;
wherein said information selecting means perform selection of guide information satisfying a time-of-day condition with expected arrival time-of-day calculated by adding the time distance to the position corresponding to said specified location calculated by said time-distance calculating means to the current time-of-day as reference.

4. The guide information providing system according to claim 3, wherein said display control means determine whether or not time difference between the time-of-day indicated by time-of-day information included in said guide information selected by said information selecting means, and the expected arrival time-of-day calculated by adding the time distance to the position correlated with said selected guide information to the current time-of-day, is equal to or smaller than a predetermined time length, and as the determination result thereof, in a case wherein said time difference is equal to or smaller than said predetermined time length, controls said display means to perform display to the effect thereof.

5. The guide information providing system according to claim 4, wherein said guide information classified by position is stored by having been classified into a plurality of types for each genre of a thing which is the object of guiding;
and wherein said terminal device further includes specified genre acceptance means configured to accept input of specification of said genre;
and wherein said time-distance calculating means calculate said time distance based on the current position information of said terminal device, and the guide information classified by position corresponding to the specified genre of which the input has been accepted and specified by said specified genre acceptance means;
and wherein said information selecting means performs selection of guide information based on the time distance information calculated by said time-distance calculating means with guide information in the guide information classified by position corresponding to said specified genre as a target.

6. The guide information providing system according to claim 5, said terminal device further comprising:
specified position acceptance means configured to accept specification regarding the position indicated by the position information correlated with the guide information selected by said information selecting means; and
route navigation means configured to perform route navigation to the specified position accepted by said specified position acceptance means.

7. The guide information providing system according to claim 6, wherein said time-distance calculating means and said information selecting means are provided in said server device.

8. The guide information providing system according to claim 7, said server device comprising:
route search means configured to perform route search from the current position of said terminal device detected by said position detecting means to the position corresponding to said specified location of the position information in said guide information classified by position to obtain route information;
wherein said route navigation means perform route navigation based on said route information obtained by said route search means.

9. The guide information providing system according to claim 1, wherein said guide information classified by position is information wherein guide information including business-hours information regarding a store or facility is correlated with position information indicating the location of the store or facility;
and wherein said information selecting means perform selection of guide information such that the business end time-of-day which said business-hours information indicates is at least the current time-of-day and thereafter.

10. The guide information providing system according to claim 1, wherein said guide information classified by position is information wherein guide information including the title information of a movie and the showing time information of the title thereof is correlated with position information indicating the location of the screen facility of the movie;
and wherein said information selecting means perform selection of guide information such that the showing start time-of-day which said showing time information indicates is at least the current time-of-day and thereafter.

11. The guide information providing system according to claim 1, wherein said guide information classified by position is information wherein guide information including the open hours information of an event and the content information of the event is correlated with position information indicating the venue of the event;
and wherein said information selecting means perform selection of guide information such that the holding end time-of-day which said open hours information indicates is at least the current time-of-day and thereafter.

12. The guide information providing system according to claim 1, wherein said information selecting means select guide information which is correlated with position information indicating the position corresponding to said specified location, and satisfies a time-of-day condition with a time-of-day obtained by adding a predetermined offset value to said time-of-day which is at least the current time-of-day and thereafter as reference.

13. The guide information providing system according to claim 12, wherein said information selecting means set said offset value variably according to a user's operations.

14. A guide information providing method comprising the steps of:
accepting input of a specified location;
storing guide information classified by position wherein guide information including time-of-day information, and position information, of a thing which is the object of guiding, are correlated;
selecting guide information which is correlated with position information indicating the position corresponding to said specified location based on the content of specified location information of which the input has been accepted in said accepting, and said guide information specified by position, and satisfies a time-of-day condition with at least the current time-of-day and thereafter as reference; and
performing display such that the guide information selected in said selecting, and position information correlated with the guide information thereof are provided to a user in a predetermined display format.

15. A server device making up an information providing system together with a terminal device, comprising:
communication means configured to perform data communication with said terminal device;
storing means configured to store guide information classified by position wherein guide information including time-of-day information, and position information, of a thing which is the object of guiding are correlated; and
control means;
wherein said control means execute
information selection processing for selecting guide information in the case of location information specified by said terminal device being received by said communication means, which is correlated with position information indicating the position corresponding to said specified location based on the content of the received specified location information and said guide information classified by position, and satisfies a time-of-day condition with at least the current time-of-day and thereafter as reference, and
transmission control processing for controlling said communication means to transmit the guide information selected in said information selection processing, and the position information correlated with the guide information thereof to said terminal device.

16. A terminal device making up a guide information presenting system together with a server device, comprising:
communication means configured to perform data communication with said server device;
display means configured to display information; and
control means;
wherein said control means execute
guide information obtaining control processing for controlling said communication means so as to periodically obtain guide information classified by position wherein guide information including time-of-day information, and position information, of a thing which is the object of guiding are correlated,
specified location acceptance processing for accepting input of a specified location,
information selection processing for selecting guide information which is correlated with position information indicating the position corresponding to said specified location based on the content of the specified location information of which the input has been accepted in said specified location acceptant processing, and said guide information classified by position obtained in said guide information obtaining control processing, and satisfies a time-of-day condition with at least the current time-of-day and thereafter as reference, and
display control processing for controlling said display means such that the guide information selected in said information selection processing, and the position information correlated with the guide information thereof are provided to a user in a predetermined display format.

17. A guide information providing system which is configured so as to include a terminal device, and a server device, comprising:
a specified location acceptance unit, provided in said terminal device, configured to accept input of a specified location;
a display unit, provided in said terminal device, configured to display information;
a storing unit, provided in said server device, configured to store guide information classified by position wherein guide information including time-of-day information, and position information, of a thing which is the object of guiding, are correlated;
an information selecting unit configured to select guide information which is correlated with position information indicating the position corresponding to said specified location based on the content of specified location information of which the input has been accepted by said specified location acceptance unit, and said guide information classified by position, and satisfies a time-of-day condition with at least the current time-of-day and thereafter as reference; and
a display control unit, provided in said terminal device, configured to control said display unit to provide the guide information selected by said information selecting unit, and position information correlated with the guide information thereof to a user in a predetermined display format.

18. A server device making up an information providing system together with a terminal device, comprising:
a communication unit configured to perform data communication with said terminal device;
a storing unit configured to store guide information classified by position wherein guide information including time-of-day information, and position information, of a thing which is the object of guiding are correlated; and
a control unit;
wherein said control unit executes
information selection processing for selecting guide information in the case of location information specified by said terminal device being received by said communication unit, which is correlated with position information indicating the position corresponding to said specified location based on the content of the received specified location information and said guide information classified by position, and satisfies a time-of-day condition with at least the current time-of-day and thereafter as reference, and
transmission control processing for controlling said communication unit to transmit the guide information selected in said information selection processing, and the position information correlated with the guide information thereof to said terminal device.

19. A terminal device making up a guide information presenting system together with a server device, comprising:
a communication unit configured to perform data communication with said server device;
a display unit configured to display information; and
a control unit;
wherein said control unit executes
guide information obtaining control processing for controlling said communication unit so as to periodically obtain guide information classified by position wherein guide information including time-of-day information, and position information, of a thing which is the object of guiding are correlated,
specified location acceptance processing for accepting input of a specified location,
information selection processing for selecting guide information which is correlated with position information indicating the position corresponding to said specified location based on the content of the specified location information of which the input has been accepted in said specified location acceptant processing, and said guide information classified by position obtained in said guide information obtaining control processing, and satisfies a time-of-day condition with at least the current time-of-day and thereafter as reference, and
display control processing for controlling said display unit such that the guide information selected in said information selection processing, and the position information correlated with the guide information thereof are provided to a user in a predetermined display format.
